(19) United States
(12) Patent Application Publication
(10) Pub. No.: US 2010/0106475 A1
(43) Pub. Date: Apr. 29, 2010

(54) BIOPHYSICAL VIRTUAL MODEL DATABASE AND APPLICATIONS

(75) Inventors: Nicolas Peter Smith, Oxford (GB); David Mortimer Budgett, Auckland (NZ); Peter John Hunter, Auckland (NZ); Duane Tearaitoa Kingwell Malcolm, Auckland (NZ); Leo Koon-Wah Cheng, Auckland (NZ); Martyn Peter Nash, Auckland (NZ); Poul Michael Fonss Nielsen, Auckland (NZ); Andrew John Pullan, Auckland (NZ); Alistair Andrew Young, Auckland (NZ); Oliver Roehrle, Auckland (NZ)

Correspondence Address: DUANE MORRIS LLP - Philadelphia;IP DEPARTMENT, 30 SOUTH 17TH STREET, PHILADELPHIA, PA, 19103-4196, US

(73) Assignee: Auckland UniServices Limited, Auckland (NZ)

(21) Appl. No.: 12/375,354

(22) PCT Filed: Aug. 3, 2007
(86) PCT No.: PCT/IB2007/002246

§ 371 Date: Dec. 16, 2009

(30) Foreign Application Priority Data
Aug. 4, 2006 (NZ) 548972

(51) Int. Cl. G06F 17/30; G06G 7/60

(52) U.S. Cl. 703/11; 707/803; 707/758; 707/E17.044; 707/E17.014; 707/705

(57) ABSTRACT

A biophysical virtual model of a body or body section of a human subject contains measured parameter values, scan data and images from surface or full body imaging systems, and also descriptive and subject identification data. Data in the model are applied to customize external objects ergonomically to fit a subject, by adjustment or by selection when the objects are configured for one or a group of subjects. The database can be centralized and/or mobile devices carried by users can supply model data to external apparatus. Where a parameter value needed for a subject is unknown, the statistical distribution of the database and the correlation of parameters can supply a probable value and level of certainty. In connection with values that are known for an individual, complexities inherent in the combination of plural parameters can be collected in the model and used in later security screens to confirm the identity of a subject.

### BACKGROUND OF THE INVENTION

1. Field of the Invention

The invention relates to creating and exploiting a data store of biophysical imaging and measurement data. Data is collected on human subjects to define a full virtual model of the physiology of a population of subjects. Certain values can be derived from image files. Other values can be inferred as statistically probable from correlation of values known for a subject to values known for others in the population.

The data store is used to customize product configurations or to make adjustments that complement a specific subject. The data enables security comparisons to determine or confirm the identity of a subject. Anonymous uses are also supported including statistical analyses of the population. The invention provides techniques that exploit biophysical information that might be typical of a healthcare system, for purposes that extend beyond healthcare.

2. Prior Art

Techniques are known by which a three dimensional model of a biological entity can be derived from real measurements, inferred data or a combination of real and inferred information. These models are computerized in a manner that enables a modeled body or selected parts, such as organs or groups of organs, to be visualized in three dimensions for a surface shape, and displayed on a monitor by computer imaging processing techniques. A primary use is in healthcare applications. Organs are modeled and displayed by visual projection to assist physicians and surgeons. In computer graphics, video applications and other fields, avatars of humans and other animals may be modeled for visual display of their external surfaces.

Anatomical structures are often modeled as static structures, but can also involve motion. Joint motions are modeled in animations for analyzing ambulatory motions, sports activities, etc., sometimes by encoding the positions of joints in successive stop images that are related to one another to infer the motion of the bones that extend between such joints. A series of X-ray images or MRI scan images may be collected wherein the images are affected by circulation of a contrast agent injected into the blood. US2004/0250210 discloses a virtual model in which a virtual muscle structure is modeled, to the degree that dynamic contraction or elongation of virtual muscles changes the surface features of a modeled face. The virtual muscle structure in that case is approximated by assigning muscle-like action to selected facial areas where underlying muscles affect facial expressions. These techniques can help to match a computer modeled face to the photograph of an actual person, even using techniques that do not rely on efforts to superimpose accurately measured bones and tissues.

US2004/0186611 teaches the technique of collecting a number of high resolution three dimensional profiles for members of a population defining a range of proportions, sizes and shapes. Thereafter, a low resolution or partial scan from a new individual can provide sufficient data points to be matched to the collected profiles, for selecting a profile that reasonably approximates the new individual. The technique involves outer surface contour representation only. Its success is a function of the statistics of the population and the number of points used in matching.

US2002/0021297 discloses a system in which a digitized depiction of a human model can be customized to an extent, namely to apply certain measurements representing individual persons, to select skin coloring and the like. The digitized model is shown in an outfit, and can be used to demonstrate moves intended to allow the viewer to assess the appearance of clothes worn by a person when in motion. The motion is predetermined and the model is not anatomically related to the viewer.

US2003/0200119 and US2005/0027562 disclose methods in which anatomic depictions of a patient are used as elements of a graphical user interface linked to patient information. There is no interaction between anatomical and functional information to provide an integrated biophysical model.

A number of patents describe techniques for visual representation of organs or of functional systems involving related organs, such as WO2004/068406, WO2005/119578, U.S. Pat. No. 6236878 and WO2006/000789. It would be advantageous, to integrate a plurality of adjacent organs in a biophysical depiction or model. It would be even more advantageous if an integrated anatomical model could contemplate and depict dynamic functions and interactions of all the organs in a modeled subject (a model representative of real body anatomy of a subject, distinct from the anatomy of other possible subjects) with functional components (e.g. muscle action, lung function, heart function etc.) wherein the functional components interact.

The subject matter of the prior art references cited above is hereby incorporated for teachings concerning the collection of image data and measurements for inclusion in a database, and making the database accessible to a digital processor, or preferably to a network of digital processors.

Apart from a model of organs and functional interactions, which would primarily be useful in healthcare applications, it may be appreciated and is an aspect of the present disclosure that a collection of data representing a human subject can be exploited to great advantage in certain applications that extend beyond healthcare. For example, a model that has sufficient data to depict organs for anatomical modeling contains information that might be applied to customize the cuts and sizes of clothes, shoes, hats or gloves, with very high accuracy. An anatomical model capable of demonstrating the interaction of organs, such as bones and muscles, has information that might be applied to determine the configuration of a machine to be operated by the modeled person, ensuring that controls are ergonomic, that supporting surfaces are comfortable and that the person has the necessary leverage to manipulate the machine without undue stress. With regard to a specific person to be identified, a sufficiently extensive collection of information can be used to distinguish that person uniquely from other persons. In contrast, with anonymous regard to a population of persons, collected information can be used to analyze the statistical distribution of dimensions and other characteristics, which is useful to those who specify products that the persons are to use.

It is an aspect of the present invention to provide a realistic virtual model of a body or body section enabling these and other new and rich applications of a collection of anatomical information to be exploited. It is further an aspect that the data store collecting the information shall have a wide range of data fields, from macro to micro scale, and certain tools whereby data elements that may be typically used, for example, in visual imaging, also can also be translated to produce measures of dimensions (e.g., girth, volume, etc.) that are useful in other applications such as the configuration of clothes or machines. As yet another aspect, these data values and the routines enabling generation of certain parameter values from other parameter values, are made accessible, with the knowledge and consent of any identifiable person whose physical data are involved, over a convenient and versatile data processing platform.

### SUMMARY OF THE INVENTION

It is an object of the invention to exploit structural and functional body data that is collected as a virtual model of the anatomy and function of a population of human subjects. The data preferably include images and measurements. In one arrangement, volume scanned image slices from medical imaging systems (e.g., from MRI or CAT scans) are provided, from which external surface and internal volumetric physical characteristics are derived using image processing techniques based on superimposing the sequence of image slices, determining surfaces from lines of contrast and measuring parameters such as length, width, circumference, distance between joints or pivots and the like.

The data are stored with reference to information identifying the subjects, for example in a relational database. The stored data includes measurement parameters that make the image data meaningful for absolute references (e.g., height, width, weight). The database can be configured to maintain minimum fields and also to accommodate additional fields, especially fields that identify subject demographics, such as age, blood type, medical or other history and any other categories and parameters, when such information is known about a given subject. Some of this information is of the sort that is useful in connection with providing healthcare services to the subjects. However the information also defines the subject uniquely.

According to an inventive aspect, the collected data can comprise biophysical specifics on individual subjects in sufficient detail to uniquely distinguish one subject from other subjects for purposes of determining or verifying a subject's identity. According to an alternative aspect, biophysical measurements can be obtained from the collected information so as to enable the customization of products or to control adjustments made to adjustable products. Such products are fitted in this way to dimensions that precisely complement the subject's dimensional characteristics. The database can be expanded further to keep a record of subject preferences.

A further application is to provide a basis for research and studies to benefit the population such as epidemiology, resource allocation planning and other uses. To a greater or lesser extent, applications according to the invention can involve access to personal information that is regarded as private, such as healthcare information governed by privacy laws. It is possible to regulate information that is referenced to specific individuals more stringently than information reported anonymously for a population. The system also can contain authorization and access regulation to ensure that information regarded as private to an individual subject can be obtained only with the subject's consent. Moreover the data store of the invention can contain biometric information and also general biophysical information that provides the basis to determine with substantial assurance that a person who ostensibly provides authorization to access sensitive information is in fact the same person to whom the sensitive information relates. The data store is useful for security applications.

Insofar as information on particular subjects is incomplete, the data that is available on a subject with respect to a given parameter can be compared to the statistical distribution of the population with respect to that parameter. Where there is acceptable correlation between parameters, knowledge of the value of the given parameter, together with processing steps applied to the population data, enables one to infer a probable value of a correlated parameter, within a range of tolerance and probability that can be derived from analysis of the data in the data store.

The data store is configured for exploitation in a number of ways that are not limited to diagnosis and management of physical and medical conditions. The data permit the customizing of products to fit or to be used by specific subjects or by statistical analysis of the population, optimizing the products to fit or to be used by a general class of subjects. The data include information sufficient for biometric identification for security authorization and access controls.

Medical information is generally private and user consent may be needed to access and use it. However, certain types of information can be depersonalized or generalized, e.g., parameter values that associate the subject with a category of users or within some range, such as blood or tissue types, gender, size ranges or the like. In a preferred embodiment, the information respecting a given subject comprises specific imaging measurements. These measurements can comprise full body MRI scan slices, CAT scans, X-ray images, etc. By providing imaging information, certain parameters can be derived from the imaging data, such as organ contours, the dimensions of bones, and the like. Using the recorded images and previous data field values, the data store can be expanded to include new derived field values, making the database inherently scalable.

The information advantageously defines not only anatomical measurements but also dynamic measurements and assays, such as stress test results, measures of sensory, cardiac, neurological and other functions and generally provides a technique whereby a comprehensive set of data values, and the interactions of elements of anatomy and physical function, are encoded, exploited and manipulated over a data processing network.

In a basic embodiment, the data model comprises a database wherein certain data fields and information files are stored that are referenced to an individual person. A basic data set can be defined to include information that identifies the person (name, address, identity code) and contains biophysical information. The biophysical information can include data files, personal measurements, and image files from healthcare sources. Examples are medical X-rays, MRI or CAT scans. The biophysical information can include security or identity related images and information, such as fingerprint images or abstracts, iris scans, notations of markings such as scars or tattoos.

In one sense, stored information comprising a database of cross referenced personal identifications, associated anatomical and biophysical information, security related information, and pictures, is similar to a database of information that a salesman might keep to describe accumulated sales contacts. However according to the invention, the database is capable of adding and appending fields, and capable of generating new fields from the existing biophysical information.

The basic data set includes biophysical information and images that are useful for purposes described herein. The data set can include or can be cross referenced to other databases and data sets associated with the persons involved. Other information that might be usefully cross referenced to individuals include financial information, genealogy (relationships to parents, progeny, siblings), descriptive information (e.g., history of place of birth, residence locations), medical history, job history, and so forth.

The biophysical model may be used to determine usability based on static and/or dynamic models; configure apparatus for a user, monitor and/or control user inputs etc. The virtual model may be stored in a portable user device and made available subject to access and security permissions controlled by the subject, to other devices such as vendors seeking to customize products and services for a given subject, authorized researchers and others.

### BRIEF DESCRIPTION OF THE DRAWINGS

There are shown in the drawings certain exemplary embodiments of the invention as presently preferred. It should be understood that these embodiments are intended to be illustrative as opposed to comprehensively depicting all variations within the scope of the invention. In the drawings,

FIG. 1 shows diagrammatically the interaction of model components of a biophysical model of a body;

FIG. 2 shows diagrammatically customization of a biophysical model of a body;

FIG. 3 illustrates customization by fitting a host mesh to user data;

FIG. 4 shows a model showing some examples for virtual model data usage;

FIG. 5 shows a system for acquiring and distributing model data;

FIG. 6 shows a method of assessing the suitability of an item of clothing by modeling the item of clothing on a biophysical virtual model;

FIG. 7 shows a system for configuring an exercise bicycle based on an individual's virtual model;

FIG. 8 shows a distributed system for customizing a model of a body and configuring a bicycle;

FIG. 9 shows a chair that is configurable based on a virtual model of the body of a user.

FIG. 10 shows a method of forming a customized product using part of a virtual model of a body;

FIG. 11 shows a gaming system utilizing virtual models of bodies;

FIG. 12 shows a dating system based on virtual models of participants;

FIG. 13 shows use of a virtual model of a body to monitor and represent progress and predict future trends

FIG. 14 shows a program for a fitness regime; and

FIG. 15 is a block diagram comparing the subject specific and population based aspects of data according to the invention.

### DETAILED DESCRIPTION OF EMBODIMENTS OF THE INVENTION

In the following description reference will be made to a biophysical virtual model of a body. In this specification reference to a “biophysical virtual model” of a body means a virtual model in which anatomical and functional components of the model interact to form an integrated biophysical virtual model. The anatomical components represent the physical form of body parts whereas the functional components of the model represent functional processes within a body such as muscle action, the circulatory system etc. Reference in this specification to a “body” can be presumed to refer to the entire body, whereas reference to a “section of a body” generally will refer to a portion of a body including at least one definable boundary surface. Reference in this specification to a “body part” refers to any part of a body.

In connection with applications that relate to configuring an external product to complement a person's body, references to the body generally refer to the external surface of the body, exemplified by a product that complements the size and shape of the person. However, the invention is also applicable to other categories of complementary configurations, such as the location and spacing of controls that need to be within reach, the orientation of movable elements to align with lines of motion, etc.

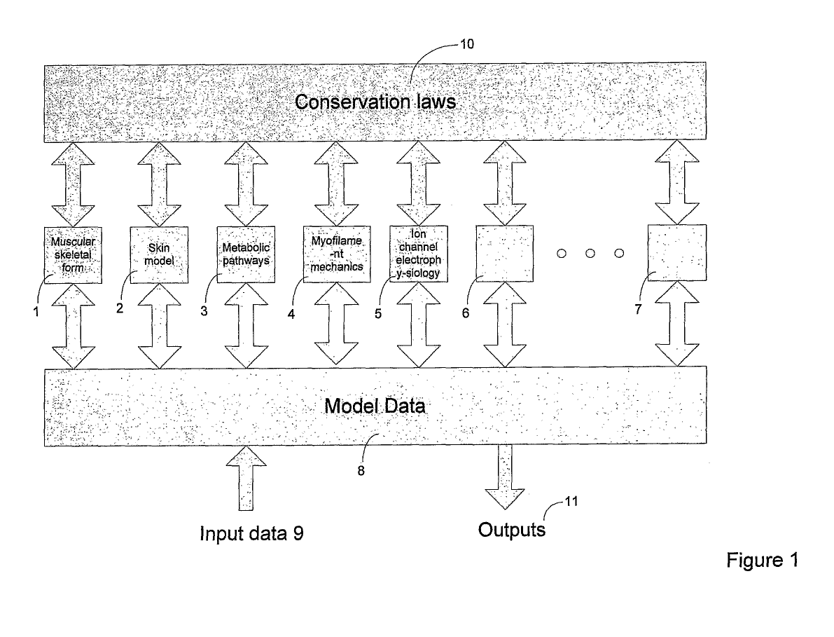

FIG. 1 shows diagrammatically a set of distinct categories that can be encompassed in a virtual model of a body, such as a human body, and for each of which categories a population of humans may be measured, imaged or otherwise recorded and thereby defined. These categories can include, for example, motion-related anatomical model components 1 and 2, which define the body with respect to shape and motion. These aspects are determined by rigid or relatively rigid members such as the skeletal bones, affixed at joints and movable by contraction of muscles, and externally enclosed in a distinct external shape by the skin. The model can include measurements and images of internal and external component body parts, sections of the body and the full body. The categories can include functional components 3 to 7, which by way of example relate to metabolic issues (such as respiration, digestion and associated endurance, endocrine functions and the like), neurology, etc., including on a macro scale and also on a micro scale.

The anatomical and functional components of the modeled body are subject to constraining rules, which are identified as conservation laws 10. These rules or conservation laws may include relationships and equations that can be used to determine the physical and functional state of a body or body component, when input data 9 is collected, applied to the components 1 to 7 subject to the conservation laws, and recorded or stored as model data 8 in a database memory. This information is recorded for a population of human subjects, preferably cross references to identifying information of the subjects.

Having collected data on subjects, the database may be queried, sorted, and subdivided with reference to a particular subject, a particular category of subjects, a range of data values and the like, either based on the constraining laws 10 or by statistical study of the information that is stored for the population. Data 11 that is produced as output from the model 8 is useful for a variety of applications as discussed below. Insofar as a partial data set may be stored for some subjects, the availability of information for other subjects permits the inference of data values by statistical methods.

Biological problems involve multiple field variables governed by multiple systems of equations which interact with each other. For example, computing mechanical stress and deformation (three-dimensional displacement fields) during movement driven by the contraction of a muscle involves solving equations derived from physical laws (e.g., from mass and inertia). Closely coupled to this are several other field variables, such as the cell trans-membrane potential in electrical excitable nerve cells (governed by the trans-membrane ionic currents and pumps encapsulated within the cell model equations and the associated diffusion processes); the extracellular potential (governed by extracellular diffusion); the oxygen partial pressure (governed by metabolic demand and vascular flow equations) and in body cavities, such as the cardiac ventricles, flow and pressure variables (governed by the Navier-Stokes equations).

Examples of some interactions between these processes in the muscular contraction are: the interaction between vascular blood pressure and tissue stress produced by muscle contraction; the direct effect that stress and deformation have on the ionic currents on nervous and other excitable tissues and hence the waves of activation; the interaction between vascular flow, oxygen delivery and metabolic demand (both via mechanical work and activation processes). These variables can be modeled in the database of information stored in the model or made available as outputs based on other information stored in the model.

Among other aspects, the model contains information respecting dimensions and movements. One difference between biological structures and engineering structures is that biology may involve complex three-dimensional shapes as opposed to simple lever arms coupled to one another at pivot axes which simplify any motion analysis. Preferably the model and the processors that access the model include certain abilities to mathematically represent complex structures efficiently.

For example, the three-dimensional geometry of the muscular skeletal system and other internal organs could be modeled by linear or quadratic finite elements (the tools of traditional engineering analysis) but it may be more efficient to use fewer higher order elements. The preferred model can contain a range of basis functions for dealing with the complex biological geometries of each component and fitting techniques to be applied to generate mathematical surface descriptions from geometric data.

The model data for the subjects in the population can come from many alternative sources, and it is feasible for information on different subjects to comprise different subsets of the model parameters and/or to be provided from different sorts of input measurement and imaging sources. For example, geometric data may be accepted and handled from X-Ray and MRI images. Various coordinate systems (rectangular Cartesian, cylindrical polar, spherical polar, prolate spheroidal, oblate spheroidal) may be used separately or on combination to define relative movements of body parts. This can often simplify the task of modeling a particular organ (e.g. prolate spheroidal references for the heart, spherical polar for the skull, etc.).

One aspect is the definition of surfaces. C1 continuous elements employ cubic Hermite basis functions which give slope continuity for both the geometric and solution variables. Thus, using C1 continuous elements, geometrically complex shapes can be modeled efficiently in a manner which preserves their visual appearance and also allows them to be used in mathematical models based on, for example, equations of motion.

In biological modeling, multiple coupled equations may need to be solved on multiple spatial regions (domains). For example, electrical current flows from the interstitial myocardial domains of the heart, brain and gastrointestinal system to the surrounding torso give rise to electric potentials picked up by ECG, EEG and EMG electrodes respectively. The electrical forward problem is to predict the distribution of potential on the body surface generated by current sources in an internal organ arising from the electrical activation of muscle. Solution of the inverse problem—estimating the electrical events in an organ from measurements of body surface potentials—is used in clinical diagnosis. These techniques, normally used as healthcare data inputs in generating the model data 8, can be useful to fully define a biophysical model of the subjects. To solve forward and inverse problems of this nature it is advantageous for all the components present in the body part to be used in the model.

An example of information that can be generated from the model is solving deformation elasticity equations on an anatomical model of muscle contraction coupled to boundary conditions which may simulate force or action applied externally. A solution can include flow and oxygen transport in blood vessels supplying organs or muscles. A variety of computational techniques can be provided, e.g., the Galerkin finite element method is apt for solving the equilibrium equations of muscle mechanics and tissue deformation; finite difference collocation is efficient in dealing with the fine spatial scale of current flow in the body; and the boundary element method is suited for solving equations on the complex anatomy of the torso.

Biological structures are typically anisotropic (i.e., having material properties that are different in different material directions). This anisotropy is often closely coupled to the underlying geometry. This model can represent material anisotropy in relation to the description of the underlying geometry by means of fiber direction fields with appropriately chosen basis functions. For example, the fibrous-sheet structure of striated muscle tissue is represented by spatially varying geometric angles defined with respect to the geometric material coordinates so that as the muscle deforms, the correct fiber angles are preserved.

Biological models, unlike many engineering models, require nonlinear material property laws. The passive elastic properties of muscle tissue, for example, are nonlinear as well as being anisotropic. The subject model formulates the material properties for efficient numerical computation. The material law can be evaluated many times during a continuum of model computations. The model can have general purpose material property descriptions and also descriptions specialized for particular tissues such as striated muscle, smooth muscle, connective tissue and adipose tissue.

According to one aspect, the biological modeling of the subjects' bodies or sections thereof can include fitting geometric aspects of anatomical data into a mathematical model. A considerable amount of anatomical detail may be needed to model complex three-dimensional geometry and fibrous structures in some biological systems. Algorithms that are useful include bicubic Hermite nodal parameters, which preserve arc length derivatives. Fitting can be linear or nonlinear and can include smoothing. An extensive anatomical database may be provided using finite element descriptions of geometry and structural anisotropy.

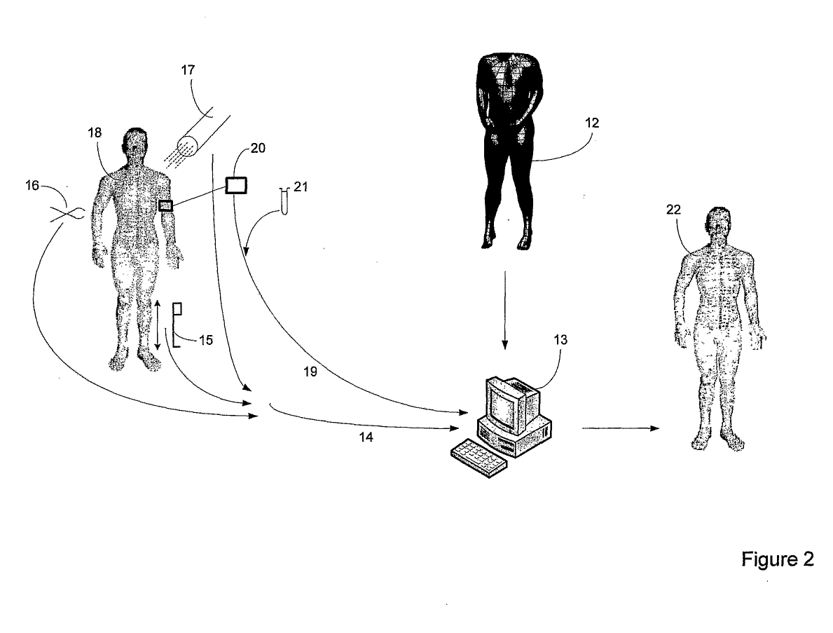

FIG. 2 demonstrates certain steps in generating a biophysical virtual model of an individual subject. The model as described above involves an organized database of information that is provided with parameter values corresponding to measurements taken on a subject 18, or inferred for the subject. Accordingly, a database having at least a generic set of parameter data fields referenced to a unique variable such as a subject's unique identity code or serial number is provided in a programmed processor 13. The parameter fields define a generic virtual model 12, awaiting information that is specific to the user. The computer is loaded with measurements of physical data 14, such as height, length or width dimensional measurements 15; caliper (thickness) measurements 16, etc. In addition to numeric data entries or the output of numerical measurement devices, the database advantageously provides for storing imaging information 17. These data values and files are acquired for each user 18 in a population, and supplied to computer 13 for storage in the database.

Preferably, functional data 19, such as blood pressure and laboratory test results 21 that might be collected for healthcare purposes are also supplied to a database stored in or accessible to computer 13. Based on the physical and/or functional data, the various parameters of the generic biophysical virtual model 12 are filled with values.

In one embodiment, the virtual model 12 is predetermined to such that the fields have default values or default values that are determined from a standardized model representing an average subject. Insofar as measurement for the specific subject differ from the average, the default values are replaced with measured values, and alternatively, the remaining default values are recomputed for the subject to conform to the rules associated with data values that are known from measurement. Using a combination of measured values and actual values, and by applying a statistical analysis to determine the averages and standard deviations of different field values and relationships, the biophysical model of the subject is filled with a combination of measured, inferred and statistically probable parameter values. These values together provide a biophysical virtual model 22 of each subject 18 whose data is represented in the database.

Insofar as more user data may be supplied for certain users as compared to others, the biophysical virtual model 22 is more accurate. The user data may include, but is not limited to physical data such as external data including internal and external dimensional data such as height, limb measurements, fat measurements, circumference measurements, etc. Additionally, morphology such as skin texture, pigment, tone, coloring, hair and eye color, contour complexity, mechanical properties of the skin, etc., may be included in the biophysical virtual model.

Image data stored in the database also can be processed to infer some of the variable values applicable to the subject. Thus, gross measurements such as total weight or weight of body section, density, volume, etc., and anatomical data (geometry and tissue structure) may be incorporated. Two dimensional or three dimensional imagery may be acquired by various forms of scanners, such as X-ray, ultrasound, CT scan, MRI, visual spectra and ultraviolet or infrared imaging cameras, etc.

Preferably, the database is provided with fields that support various statistical analyses. Also, genetic data, functional data such as cardiovascular measurements such as electrocardiograms, blood pressure, pulse rate, respiratory measurements such as lung capacity, air flow rates, lung efficiency, etc., sensory data such as data relating to vision, hearing, taste and smell, diagnostic results from body fluid analysis such as blood chemistry and glucose, etc., and performance data from physical exercise, etc., all may be included in aspects of the biophysical virtual model of the present invention. Other data may also be stored in the model to provide additional functionality. This additional data may include preferences, food intolerances, allergies, medical records, notes, history of illnesses and injuries etc.

In the simplest implementation the generic biophysical model may be customized using a single piece of user physical or functional data such as height, weight etc. As further user data is provided the model can be better customized to a user. Profiles may be developed based on age, sex, ethnicity etc. so that the model is better optimized to a user. Customization may relate to only certain aspects such as physical appearance through to a fully customized biophysical model of a user.

Where imagery is available, further anatomical modeling may be developed. Using image segmentation tools bounding lines or surfaces may be extracted from medical imaging data. Points identified on lines or surfaces are fitted to the generic model using least squares or other optimization techniques.

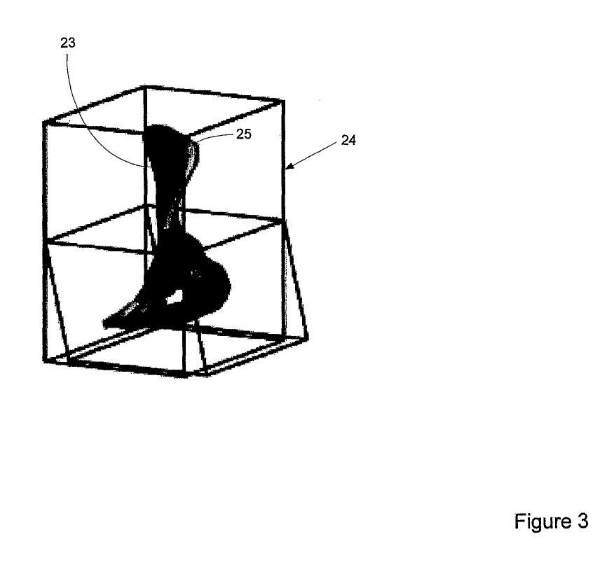

FIG. 3 illustrates a method of fitting a generic biophysical virtual model of a body part to user specific data. A generic model 23 (dark shading) is fitted within a host mesh 24 (outlined boxes). Fiducial points from the generic model are mapped to the corresponding points of the user data. The nodal parameters of the host mesh are used to optimize the fit (light shaded element 25). The number of elements and nodes in the host mesh is selected to match the complexity of the necessary distortions to map the generic mesh onto the patient data. Features of external appearance may be customized based on photographs or three dimensional imagery. Texture mapping techniques may be employed to produce realistic skin texture.

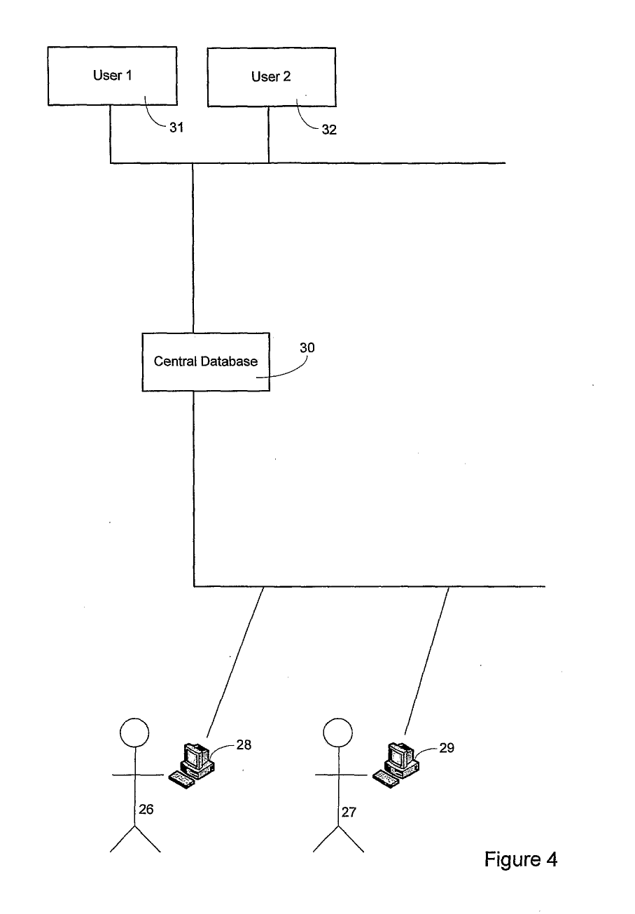

FIG. 4 shows a centralized system in which individuals 26 and 27 may enter personal details via computer terminals 28 and 29 to supply personal data to central computer database 30. A central computer associated with the database 30 may customize a virtual biophysical model based on the data supplied and store the customized virtual model and/or supply model data to the user's computer. In obtaining the personal data, programming at the central computer database 30 or at the terminals 28, 29, operate to prompt the user 26 or 27 for data entry. Alternatively or in addition, the terminals 28, 29 can be associated with an operation such as a clinic, where measurement data and images are recorded and uploaded, in addition to information that the user (typically the subject) supplies in response to prompts.

Users may opt to control access to their information in various ways. According to one option, permission to access and obtain all or portions of a subject's customized model data may be granted, or granted to specifically identified users 31 and 32. It is possible to control access to personal medical information while nevertheless benefiting from the ability to customize products or services to complement a subject as defined in the model and/or the ability to use the model data on a subject to determine or verify the subject's identity. According to one aspect, particular database fields, such as diagnostic data that is regarded as sensitive, can be made inaccessible to remote users. Database fields that are non-confidential can be made available. It is possible to designate fields as confidential per se. Alternatively or for some fields, the subject can be given an option to make the ultimate decision as to confidentiality, thereby honoring the subject's privacy in situations wherein a particular subject may regard a field as confidential (for example, a subject with a particularly large shoe size might consider the shoe size field as confidential whereas a person with an average size in that field might not).

According to an inventive aspect, insofar as data fields for a subject are not populated with information, processing of the data stored for the population can provide an average or mean value over the population for a missing field value and a standard deviation value representing the extent of variation found in the population. Analyzing the data for a distribution of values over the population is an anonymous function and is preferably permitted by the statistical analysis subroutines made available for processing data in the database, regardless of whether or not the subject may regard their particular data value as confidential. The data value may be read and used as a statistical input but is not associated with the subject and thus does not amount to a breach of privacy.

Data analysis as described can be used to infer a likely value for a missing field. In this respect, it is preferable to process the population data in a manner that recognizes the cross correlation of certain data values. Thus, for example, if the desired output is a clothing size such as a waist or neck circumference, it may be possible from the model data to infer from available height and weight information the most likely value for an unavailable measurement of these variables.

Particular entities for which access to database entries is advantageous for one purpose or another fall into two different groups that might or might not require knowledge of the identity of the subject and/or may or may not need access to all the model data on the subject. Full access to data may be appropriate, for example, for a physician engaged in diagnostic efforts. On the other hand, a tailor or custom fitting service for clothes, shoes, prosthetic devices or the like may need access to particular measurements only, namely the measurements associated with a particular product to be fitted.

In connection with anonymous access to the database information, suppliers of products may advantageously obtain studies conducted on the database information to determine the distribution of sizes over the population of subjects. A knowledge of the distribution of sizes among customers assists in the efficient allocation of resources by ensuring that products are made in the sizes that correspond substantially to the profiles of the prospective customers. Statistical studies are helpful in a similar way. For example a mass transit operation may plan the optimal size of passenger seats or berths to accommodate a given percentage of passengers, neither too big so as to waste space nor too small so as to be uncomfortable or unusable for certain passengers, efficiently providing for unusually sized passengers with alternative seats or berths.

Similarly, anonymous studies may be conducted to study the cross correlation of different values. This information is comparable to epidemiological analyses, for example, that relate conditions such as circulatory or endocrine conditions to body weight. In connection with subject dimensions, the correlations assist in the efficient configuration of products.

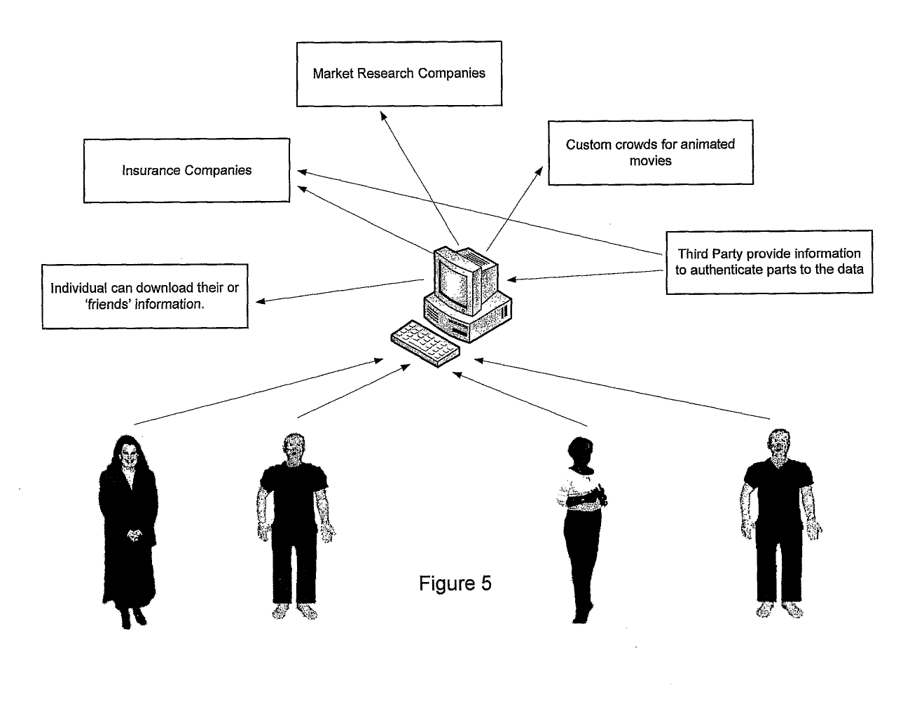

FIG. 5 demonstrates a number of entities that may have use for biophysical model information, either specific to the subject or anonymous. In addition to medical applications by a doctor, other users may be authorized to receive at least selected categories of data. Insofar as certain of the entities stand to gain from access to the data, it is possible to assess a user fee, thus helping to support the system.

A doctor might be entitled to receive all the data and to identify a subject. A clothing manufacturer seeking to fit a subject may be authorized to obtain certain information on an identified subject only, such as measurement information as to the exterior form of the body section for which clothing is required to be fitted at the subject's request. The same clothing manufacturer might seek anonymous access to the measurement data of the full subject population and be willing to pay for the information. That manufacturer might pay more to obtain such measurements and also information on the age or gender or other demographics of the subjects so as to facilitate marketing. A hierarchy of any desired number of levels may be developed. Appropriate security techniques and access may be employed including key encryption, certificates etc. Third parties may provide validation of certain information (e.g. doctors or medical laboratories may provide electronic certification of data provided to the model).

Different types of information stored in the biophysical virtual model may have different levels of protection. Information such as the user's height might be provided upon request. However, more sensitive information, such as sensitive medical information, should require user consent for release. A certification system may be employed so that certain levels of information are only provided to appropriately certified parties. As well as anatomical and functional information the model may store medical and dental information, stress test or exercise performance measurements, product preferences and other information a user may wish to attach to the model.

Among other data stored to define the biophysical model of the subject, biometric information may be stored and used as a security mechanism to authorize a financial transaction, allow use of equipment, allow entry to a building, validate identity etc. This could include biometric information such as a user's fingerprint, iris image, retina scan, etc. The potential for the biophysical profile data store is such that the biophysical information might not be limited to static appearance, but could also include walking gait or other characteristics that may be used for identification. The information can also include test results such as blood or tissue type, DNA marker sequences, etc.

Referring to FIG. 5, individuals can be provided a right to download their own information or to authorize downloading by others such as identified friends, entities such as medical service entities having need of the information, other entities with whom the subject may contract such as an insurance company or an employer. Other entities may wish to negotiate for access to the information, presumably in consideration of some benefit provided or payment made to the subjects. Examples are market research companies, those who wish to obtain a population distribution of images or other data (e.g., graphic artists or animators), companies who seek to verify information already in their possession and so forth. These are just a non-limiting sample of the many possible applications for the information.

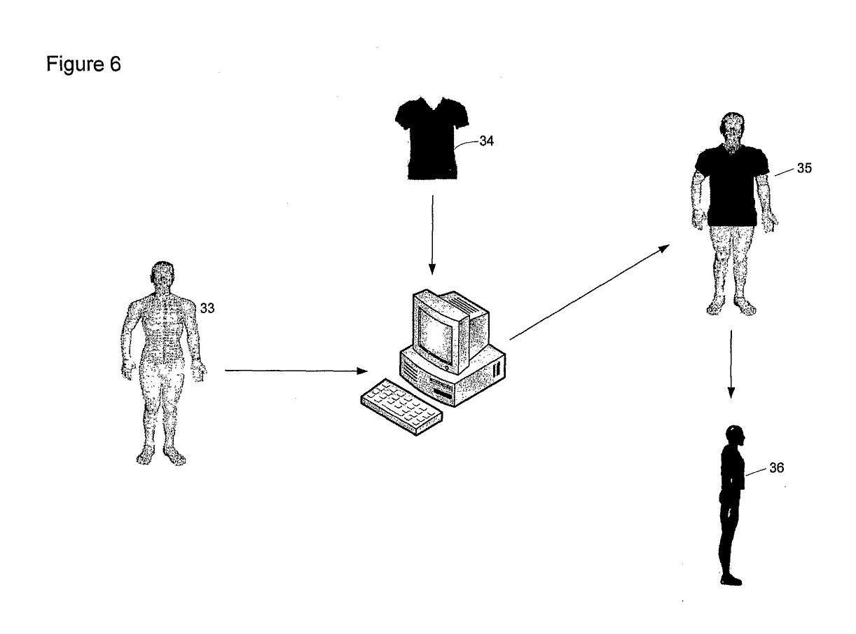

Referring FIG. 6, a method of online shopping can benefit from the availability of biophysical model data for matching products to the size and shape of a customer's body or body part. In this example, the subject supplies data from their virtual biophysical model 33 to an electronic retailer, or provides to the database process an authorization to reply to an identified E-retailer's inquiries regarding certain data fields. Such fields can represent the dimensions of the subject with respect to certain measurements that the E-retailer may use to define product sizes, in FIG. 6, to match the dimensions of a nominal shirt 34 to the subject, but adjusting the nominal size with reference to the stored biophysical user data to produce a customized shirt 35.

In this example a virtual model 34 of the shirt is fitted to the virtual biophysical model 33 of the subject. The subject may be shown the display of an image 35 in which the shirt is fitted to the virtual biophysical model, from which the subject may judge fit to suit the subject's preference. In one embodiment, the virtual biophysical model may be manipulated through the ranges of possible movement that have been encoded or that can be processed from available data, to illustrate the fit of the shirt while the virtual subject is moving.

The biophysical model can be accurate and detailed, particularly if the contents of the database are based on various layers and internal structures of the body (i.e., muscle, fat, etc., as determined from MRI sources for example). A realistic representation of the garment in use is thereby provided. It will be appreciated that an E-retailer may utilize the virtual biophysical model of a user to produce a garment specifically tailored to that user, or to select from an inventory a size that is thus tested as to fit and preference.

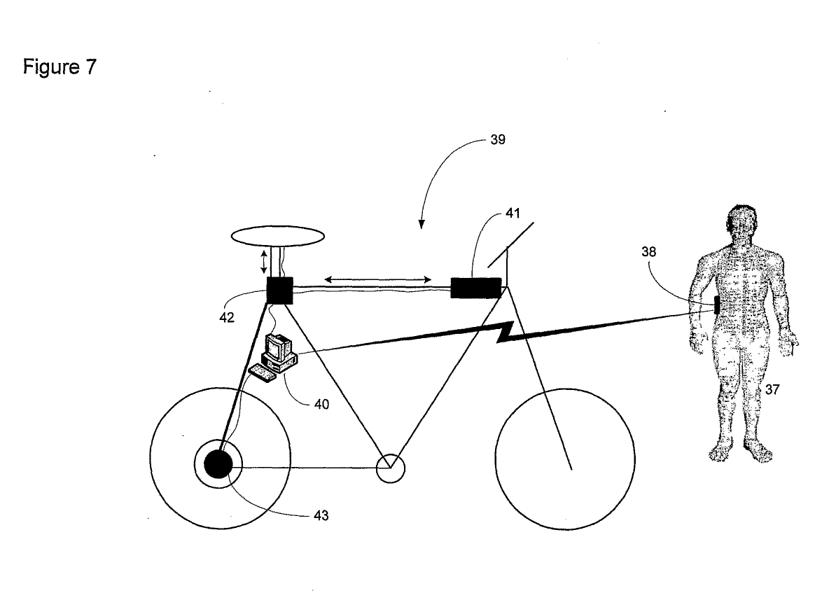

FIG. 7 similarly shows an embodiment in which a mechanical article is configured or selected for a subject based upon the subject's virtual biophysical model. The exemplary subject, namely user 37 in this case, carries a mobile wireless device 38 that stores or provides data communication access to the virtual biophysical model of the user, or at least a part of the model that is pertinent to the product at issue, in this example an exercise bike 39 that has adjustable features. The exercise bicycle 39 has adjusting facilities such as a control computer 40 capable of adjusting the frame by extending or retracting a frame bar via actuator 41, by raising or lowering the seat height via actuator 42 and so forth. The adjustments are not limited to dimensioning, and may provide a means to adjust the energy expended by the subject by adjusting a resistance load device, or simply to monitor the user's energy expenditure by monitoring the output of drive 43 comprising a generator or other device to produce a signal.

To configure or adjust the exercise bike for the subject 37, appropriate data sent from or based upon their virtual biophysical model is communicated via wireless device 38 to computer 40 via a wireless link. Computer 40 adjusts the actuators 41 and 42 if needed, so that the bike is optimally configured for the subject 37. The load applied to drive 43 may be adjusted to suit the physical capabilities or fitness of the user and in accordance with a desired exercise regime.

Although product configuration customizing has been described in relation to an exercise apparatus, this is one example of a concept that may be applied to any configurable article where there is a relationship between the article and a physical or functional characteristic of the user's body. That characteristic is encoded as one or more values stored in the biophysical virtual model, or the characteristic is derived from data in the biophysical virtual model. If all the values to conclude a value for the characteristic are not available, access to a virtual model data store that includes information on other users enables the required value to be estimated or inferred according to some probability.

In this way, a product such as a car seat in a vehicle can be sized for a subject and placed in ergonomic proximity to controls that the subject is to use. Articles of furniture can be customized such as the size or height of a chair or bed etc. Likewise, an environment may be configured for a user to suit light levels appropriate for their vision, sound levels appropriate for their hearing, temperature in accordance with their preferences etc. as stored in the model. It will be appreciated that a wide range of portable devices could be used to store the model such as mobile phones, Pocket PCs, PDAs, MP3 players, Flash drives, cameras etc. Such devices, or the device to be configured, can be arranged to store a set of settings and to read out or return to the settings that were previously stored, when selected by a user who simply provides an identification code corresponding to such settings.

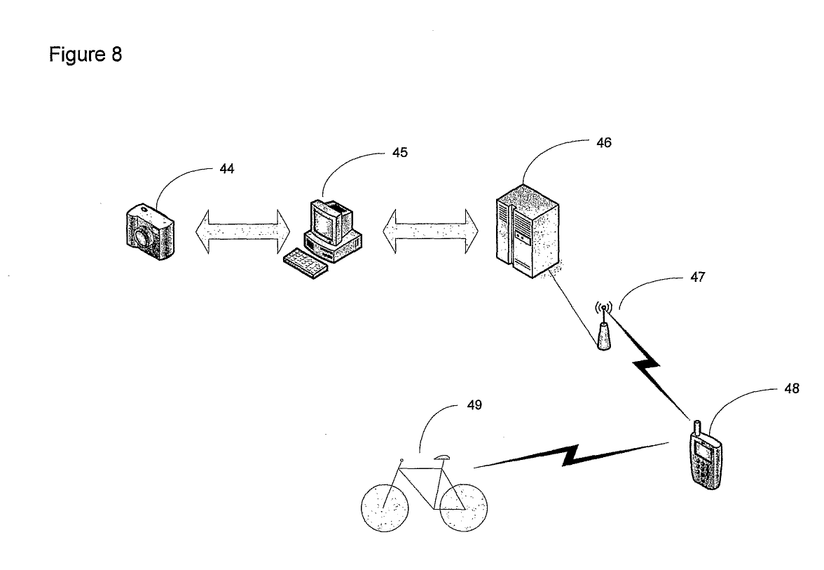

FIG. 8 discloses a generalized depiction of a system based on the concept illustrated in FIG. 7 with respect to an exercise bike. A data acquisition device 44 obtains user specific information, such as a camera image, and provides this via a local computer 45 to a data store such as a central computer system 46 available over a wireless network 47. Information may also be input via a keyboard and other input devices. This user information may be processed to develop further values, e.g., to derive variable value from as a function of input values. The data is supplied to central computer 46 which stores a virtual biophysical model from which a customized biophysical model of the user is derived.

A user or subject may download a virtual biophysical model or relevant portions via wireless network 47 to cell phone 48. Cell phone 48 may transmit relevant data to appliance 49 so that it may be configured for the user. Transmission of the virtual biophysical model is preferably over a secure network and may utilize encryption and/or password protection. This approach has the advantage that the entire virtual biophysical model need not be stored on the cell phone 48 and the most up-to-date biophysical model may be downloaded as required.

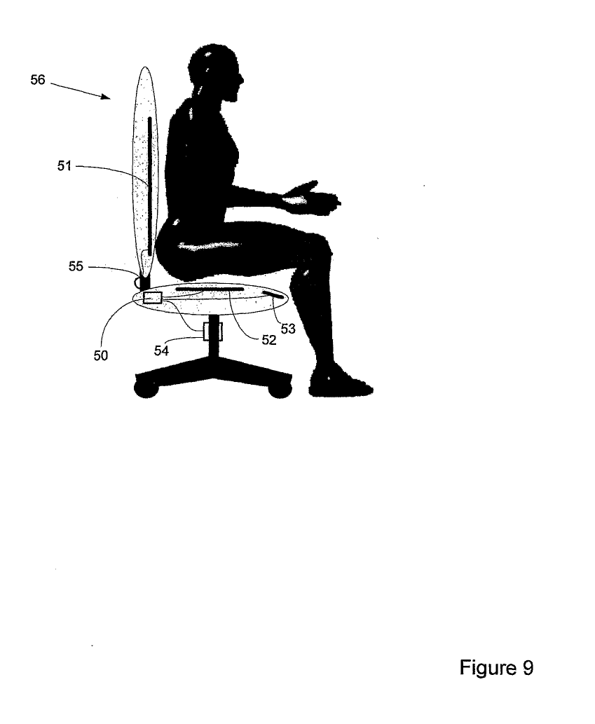

FIG. 9 illustrates the selection or adjustment of the configuration of a chair to complement a user's dimensions and optional preferences. In this case a biophysical model for a user may be transmitted to controller 50 as in previous examples. Alternatively, or additionally, sensors 51 to 53 are provided to measure weight and mass distribution for the user. This information is used further to customize the model stored in controller 50 for one or more users for whom the chair configuration is customized and who can select their predetermined settings to cause the chair to conform.

In this case, the dimensions, weight and mass distribution of the subject and the user's preferences can all be referenced to customize the model from which the chair is configured for the subject. Furthermore, the information gained from sensors 51 to 53 may be transmitted or uploaded back, using one or other techniques of communication or transfer of settings, to the biophysical model stored centrally. This new data is then incorporated into the database of information used by the model for the population of users.

In the case of a product adjustment, the amount of data needed to adjust the product to a predetermined set of settings (e.g., chair, exercise bike or other product) is small compared to the information that might be referenced from the subject's biophysical model to configure an adjustable chair with optimized settings. Further, there may be two or more sets of preferred settings, for different users or for the same user at different times of day or for distinct activities. Actuators 54 and 55 may be driven by controller 52 to configure the chair 56 for a user. The same considerations apply to a range of applications wherein measurements enable the generic settings or configurations of a product to be selected or adjusted “on-the-fly” to complement a particular user.

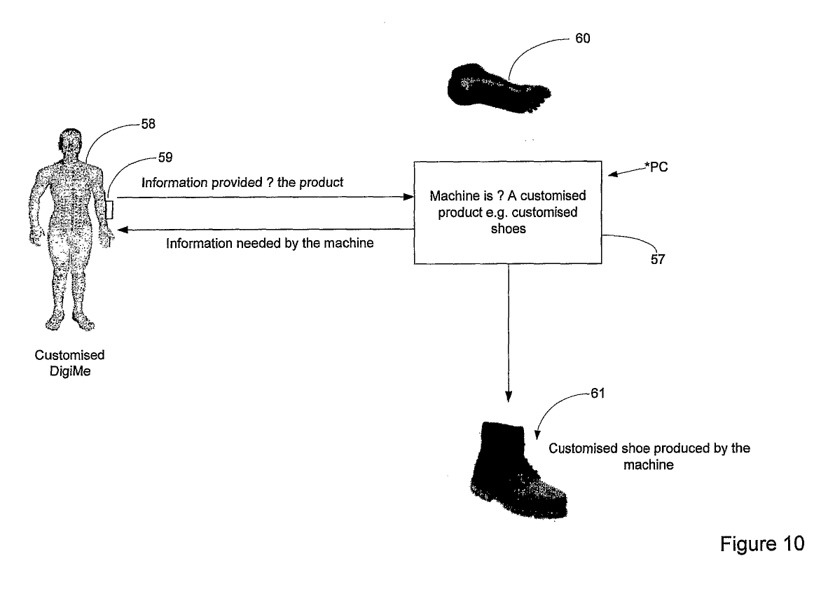

FIG. 10 illustrates the application of the inventive method to producing an article that is customized as to fit. In the illustrated example, the customized article is a shoe, although it will be appreciated that the article could be any of a wide range of customizable articles. As above, a computer controlled machine 57 obtains user data, for example by querying for data communication from a wireless device carried by user 58, defining the size and shape of the user's foot, and potentially also certain more specific structural aspects such as the location of joints, the state of the arch or instep, etc. The information requested may depend upon the information required by the computer controlled machine 57 for customization of the specific product, namely show 61. Alternatively, the communicated information can comprise a set of predetermined variables that are applicable to shoes, socks, prosthetic foot supports or the like and are generally available in the model to define the subject's dimensions and preferences as to footwear. The user mobile device 59 may respond supplying the external profile of the user's foot 60 or by reporting on the correct values for this user as to the predetermined variables. In either case, the information is used to produce a customized shoe 61 that fits the user.

The invention is not limited to dimensions. In the case of a product designer who is configuring a shoe design that may be customized for a range of subjects in a population, the shoe designer configures the shoe for a user's foot and also considers functional information. For example, flexing in walking may determine the placement of structures of the shoe. Considerations such as how the temperature of the user's foot will be affected by the shoe can be modeled and considered. The pressure profile exerted by the footwear on the foot and vice versa during walking/running/jumping might be modeled. The effect of the shoe on blood circulation can be modeled. These considerations can be studied for nominally healthy users and also by applying conditions, such as to model users with arthritis, those with broken bones to be supported while healing, etc.

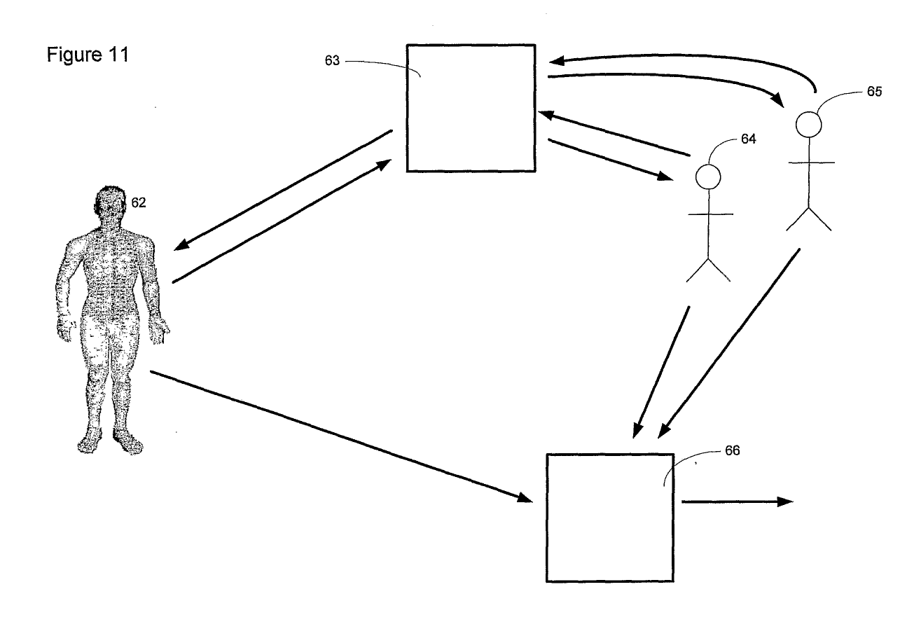

As shown in FIG. 11, the virtual biophysical model of the subject can be used to represent the subject in the virtual world as well, i.e., in computer graphics, animation and video gaming. The virtual gaming application of FIG. 11 permits a gaming device 63 to obtain from data associated with user 62 information required to produce a representation of the user in video graphics, e.g., to compose an avatar to represent the user accurately in a game. The user may supply the requested information from their virtual biophysical model to the game console and an avatar 65 representative of player 62 may be produced. An avatar 64 of another user, e.g., an average user, a randomly selected user, a competing player or the like, may represent the opponent during game play. This enables gaming device 63 to produce games having characters visually representative of users and their associates.

The avatar can be embodied with the appearance and functionality of a modeled subject, such that a user is restricted by their own physical capabilities. Alternatively, the initial capabilities of a user may be enhanced as part of the game, e.g., as a result of game play or upon purchase of capabilities for game credits, etc. Avatars 64 and 65 may also be provided to a game company 66 so that a customized game may be produced incorporating avatars with known capabilities against which users may compete. Thus it is possible to vie with historical persons, heroes, particularly successful competing game players and the like. Information may be provided directly from player 62 to game company 66.

Apart from video games, virtual models may also be used as online avatars to guide a user, for teleconferencing to reduce required bandwidth for visual data transmission (especially for mobile phones), etc. According to the invention, the avatar can resemble a desired subject in various sometimes realistic ways.

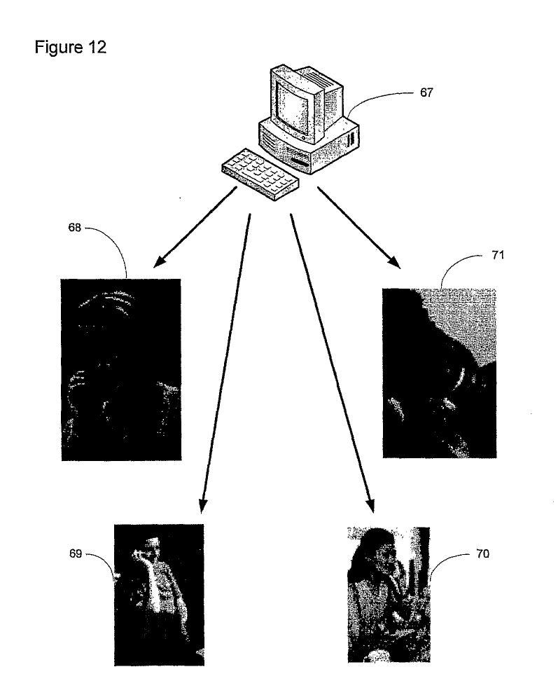

The virtual biophysical model may be utilized in social situations such as dating applications as shown in FIG. 12. Users 68 to 71 may provide all or part of their virtual model to a dating or social networking database 67. Where the information is certified, the model may be used by a contact to confirm that attributes claimed by an individual are reflected by the model information. The model may be supplied to dating agencies to match individuals and potentially to include fields that contribute to obtaining a score as to compatibility.

The model of the invention may be embodied to include aspects of social typing as well as physical measurements, images, biological function and the like. In view of the depth of information available, detailed matching may be performed provided the fields are maintained, or if field values are missing, values can be inferred according to probabilities based on the population data.

Online, or in a wireless environment, individuals may choose to make selected portions of their virtual biophysical model available to a social networking partner. Alternatively, the information can be restricted to access by a matching service rather than the partner, in which the partner receives instead a score or a true/false verification report on one or more queried aspects.

If the biophysical model information or an abstract or subset of the model is stored on a mobile device or is accessible using a mobile device, the mobile device may be programmed to communicate parts of the model to local wireless devices according to security protocols or otherwise. This may be via a short range ad hoc network communication link such as Bluetooth or using location dependent information technologies (e.g. GPS enabled phones). When values of a virtual biophysical model for one person are compared and meet specified criteria of another, one of both of the persons can be notified by their programmed device that a person meeting their criteria is at hand. In one potential embodiment, the phone numbers of either or both persons may be reported to one another so that contact can be initiated, bringing some adventure and excitement into the process.

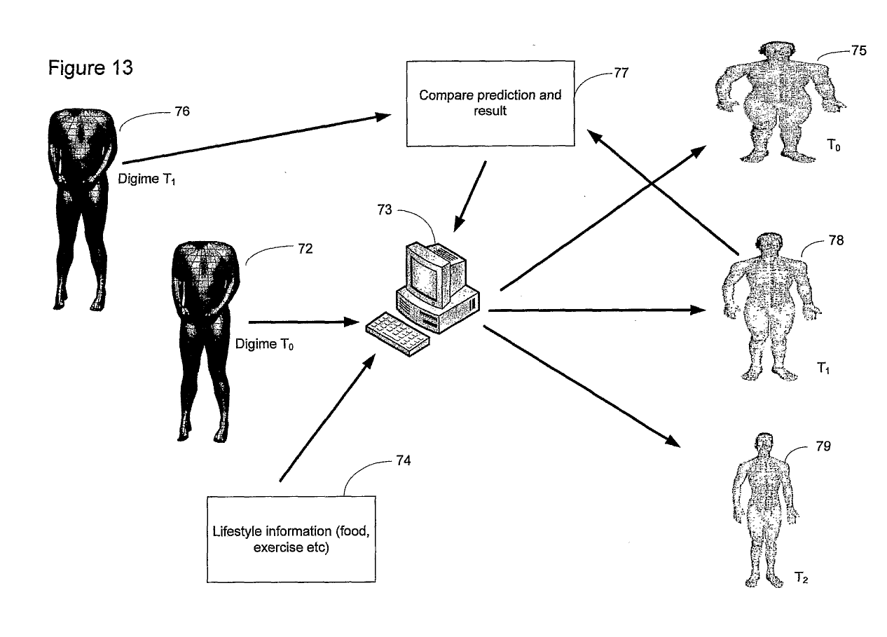

FIG. 13 depicts a dieting and/or exercise application in which physical and/or functional information forms a virtual biophysical model 72 for a subject who intends to initiate a weigh loss or muscle toning regimen. This model is input into a computing device 73 at the beginning of a program. A proposed lifestyle program 74 is input into computing device 73 and contains projections to generate an initial representation 75 of the individual at the beginning (To). Predicted representations 78 and 79 of the individual if the lifestyle program is followed may be generated. After a period of time (T1) further physical and/or functional measurements may be obtained to generate a virtual biophysical model 76 of the user at time T1. Model 76 may be compared with predicted model 78 to evaluate progress and predict likely future changes if the lifestyle model 74 is followed. Progress may be displayed by graphs (e.g. fat content, weight etc.) over time or by accentuating features on a representation of the individual displayed to the individual (e.g. red portions in detecting additional fat to that projected or green indicating greater fat reduction).

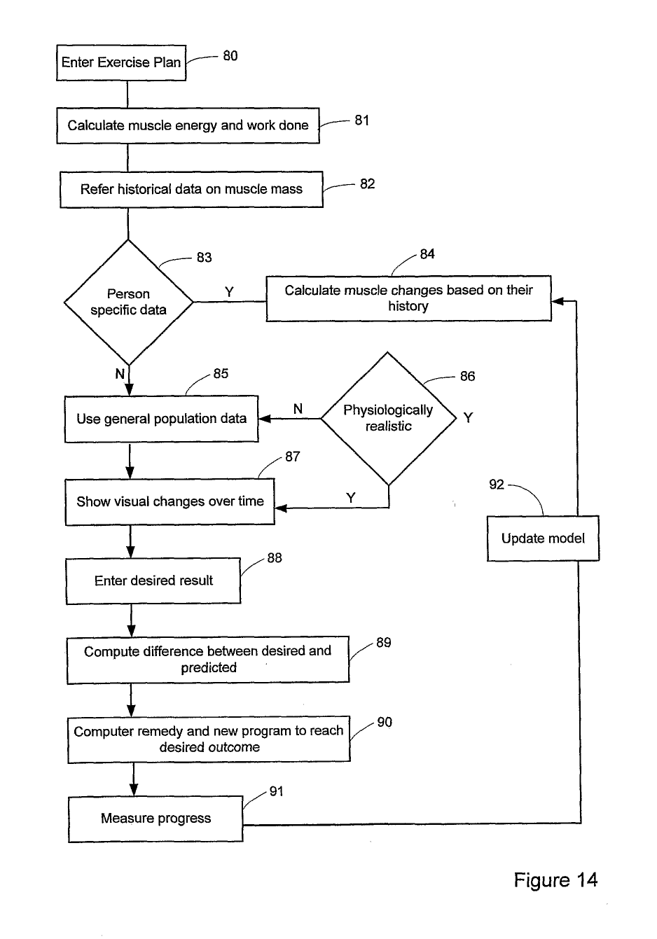

FIG. 14 shows a method of modeling body change as a result of following an exercise plan. An exercise plan is created at step 80 and the muscle energy and work done is calculated in step 81. This is related to historical data on muscle mass in step 82. If specific data is available from a virtual biophysical model for a user in step 83 then muscle change for the exercise plan is calculated in step 84 based on the user's historical data. If the result is considered to be physiologically realistic then these changes are shown over time in step 87 (e.g. by a graph or representations of the change for the individual). If the result is not considered to be physiologically realistic or there is no specific data for the individual then general population data is used to estimate the changes for the individual. The individual can then select the result they wish to achieve in step 88 and in step 89 the difference between their desired result and what it is predicted using the exercise plan is predicted. A new exercise plan to achieve the desired result may then be generated in step 90. The individual's performance may be recorded manually or automatically transferred to their virtual model in step 91 as discussed above. The model may then be updated in step 92 and processing returns to step 84 for a further iteration.

According to an aspect of the invention, the database of stored information is useful both for methods applicable to single subjects and to studies directed to a class of subjects or to the full population of subjects. At least minimal database fields are entered so as to identify subjects and to permit the subjects to be categorized as to class if a class of subjects is to be studied. Insofar as more data fields have been populated for some subjects than other subjects, it is possible to infer field values for subjects based on their classification, to an accuracy that can be determined by statistical measures. Thus, for example assuming that a subject has data entered for a set of variables enabling a classification by gender, age and weight, it is possible to assume statistically the value of a field for which data on the subject is missing, such as height. This process involves selecting available records of other subjects with comparable values of gender, age and weight (in this example) and calculating the average and standard deviation of their heights. The result is a distribution wherein one can infer an average height for the selected classification of gender, age and weight, and a probability of the height of the subject for whom height data was not available.

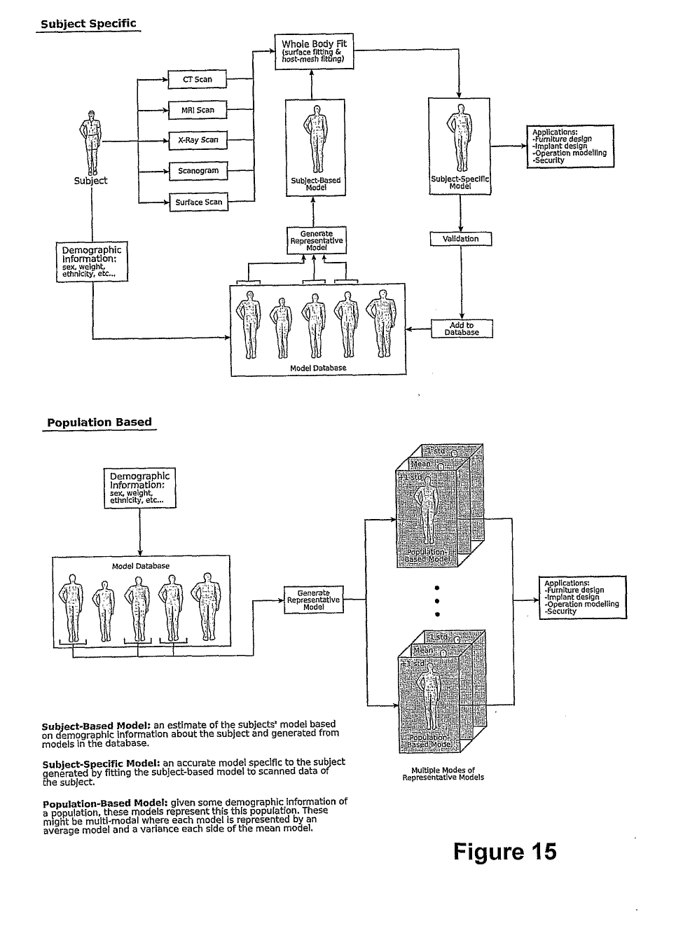

Thus, referring to FIG. 15, both subject specific and population based information can be studied, with corresponding benefits as to the subject and as to the population. In an ideal embodiment, data on a substantial proportion of a large number of subjects is collected in detail, using for example CT, MRI, X-Ray, scanogram and visual imaging to model the structural and functional internal and external structures of the subject. In addition, biological test results, medical histories and other information can be obtained for the overall subject and also for specific biological systems (such as cardio function, for example). For epidemiological studies, the gender, ethnicity, residence location and other factors can be entered. These values contribute to generating a model of the particular subject. The models of the numerous particular subjects are stored in the database.

Products or services then can be customized to fit identified individual subjects. Alternatively, a product or service for wider use can be studied to ensure that a wide range of subjects can use the product or service, or to maximize the ergonomic choices made for products to an optimally large proportion of the population. In terms of products, structural parts that are to support or contact the subject can be fitted. Movable parts can be aligned to the subject's limbs and joints. If it appears necessary to subdivide products by size ranges, this can be accommodated with a knowledge of the proportions of subjects likely to fall into different sizes.

Once loaded, the model database of numerous subjects allows any number of studies to be carried out with statistical probabilities arising from the nature of the sample data, cross-correlations between variables and similar statistical measures.

Applying the subject specific model and the population based general model to a product configuration can be considered with reference to a product such as a chair or other article of furniture. Using medical imaging devices, a highly detailed three-dimensional model of subjects can be developed, and the variance of each given subject from average nominal dimensions can be encoded as the variables that model the structural aspects of specific subjects. For population based study, the averages and standard deviations as to such variables can be derived by straightforward mathematics. The result is a generic model of the average subject, a specific model for each subject for whom measurements have been taken, and a statistical store of information defining the distribution of the population. Where necessary, the statistical distribution of the population enables reasoned estimations of missing values for subjects that have not been measured, tested, imaged or similarly encoded to the fullest possible level of detail.

The technique can apply to a variety of applications wherein an interaction is to occur between one or more human bodies and external devices, such as an office chair that is to be configured for a specific subject or optimized for subjects who fall within some range or category. In one application, configuration decisions can determine the height of the seat, the size and contour of the seat, the contour and tilt of the back, the relative positions and the contour of the arm rests, and so forth. These configuration decisions adapt and configure the general model of an office chair, to match the skeletal and muscular features of the specific subject.

The skeletal specifications of the subjects are determined by known medical imaging techniques. Furthermore, by extending the model to encompass internal biological subsystems, such as circulation, the model enables stresses and deformations that result from the interaction with external devices to be calculated when configuring devices to fit a specific subject.

In an example, processes were followed to perform the customization using intensive computation to operate a mechanical model of the subject, while testing the effects of forces applied due to the weight and contours of the subject versus the contours and resilience of the supporting surfaces of the product, in this example an office chair. These processes were carried out in testing using an IBM pSeries 595 high performance computer with sixty four 1.95 GHz processors, and 256 GB memory. An anatomical software suite for modeling work was the CMISS package developed at the Bioengineering Institute of the University of Auckland, NZ. The CMISS software provides many tools which enable mesh development using higher order elements, customization, and finite deformation mechanics to be carried out with a single package. CMISS comprises an interactive computer program for Continuum Mechanics, Image analysis, Signal processing and System Identification. The CMISS mathematical modeling environment allows the application of finite element analysis, boundary element and collocation techniques to a variety of complex bioengineering problems. The system comprises a number of modules including a graphical front end with advanced 3D display and modeling capabilities, and a computational backend that may be run remotely on powerful workstations or supercomputers.

The anatomical model is customized to a specific subject using the host mesh fitting technique. Host mesh fitting is a variant of free-form deformation which takes generic geometries and morphs them to subject specific models using control points called landmark and target points. In host mesh fitting there are two meshes—a host mesh and a slave mesh. The slave mesh describes the geometry of the object to be customized (such as the normalized skin surface of a generic model, the points of which correspond to an average, mean or otherwise standardized set). The host mesh can be a low resolution mesh of a few elements that surrounds the slave mesh. The host mesh fitting process requires data describing the position to which an object will deform under stress (e.g., the supported weight of the subject).

One method for collecting a large quantity of suitable shape or surface data is to use a laser scanner. Scanning a subject from alternative perspectives produces thousands of data points. A subset of points are selected which describe the overall geometry of the subject (which can be relatively more densely placed for smaller structures, facial features or the like).

Landmark (initial) points are selected on the skin surface of the generic model (the one to be deformed) while target points are selected to define the position of the landmarks in the customized state (so these come from the scanned data as that is the position we want to deform the generic model to). The relative location of each individual target point is selected to correspond as closely as possible to the relative position of the landmark point that it matches.

In the case of an office chair analysis, the landmark and target points are chosen to include strategically identified locations associated with anatomical structures associated with sitting, e.g., the hips, back, joints such as knees and ankles, etc. More points are selected between the identified locations until the overall shape of the model has been captured. A larger number of control points generally produce a more accurate transformation. A smaller number of points reduce the computation time. The goal of the implementation is to keep the number of points low while retaining sufficient accuracy for the transformation. Generally, the appropriate resolution is somewhat finer than the size of the anatomical structures that are involved.

Both Euclidean (translation and rotation) and Affine (Euclidean plus scaling and shearing) operations are performed during the host mesh fitting procedure. Once the landmark and target points have been selected, the host mesh is deformed to minimize the objective function F:

$$F ( {u}_{n} ) = {\sum }_{d = 1}^{N} {w}_{d} {‖ u ( {ξ}_{1 d} , {ξ}_{2 d} , {ξ}_{3 d} ) - {z}_{d} ‖}^{2} + {F}_{S} ( {u}_{n} )$$

where uₙ are the mesh nodal parameters (global coordinates and derivatives), N is the total number of data points, z_{d} are the geometric coordinates of the target points, wd is a weight for each data point u_{(ξ}_{_{1d}},ξ_{_{2d}},ξ_{_{3d)}} is the projection of the landmark points, and Fs is the Sobolev smoothing function.

The objective function is the sum of the squares of distances between each data point and its projection onto the element, plus a Sobolev smoothing factor. The Sobolev smoothing factor enables the arc length, arc curvature and face area of elements to be controlled by altering weights associated with these factors in different ξ directions. The data points are projected onto the faces and the distance between the data point and its projection are minimized.

The deformed model is then re-fitted to the original scan data to improve the accuracy of the fit. This is necessary because only a fraction of the scanned data is required for use when deforming the generic model. In between these points, some error may be introduced if the interspersed points are not rigidly constrained. Tens of thousands of data points are then generated on the surface of this deformed model and corresponding points are generated on the surface of the generic model. Host mesh fitting is again performed to produce an accurate model that is both specific to the subject and has the high level of detail contained in the generic model. This final host-mesh fitting step gives us the overall transformation from the generic model to the model customized to the subject. This model defines the surface of the subject. The transformation can be applied to encode the surfaces of deformable structures in the body, which can then be modeled with the application of force or stress.

The bones can be modeled as substantially rigid elements connected to one another at joints that constrain their degrees of freedom. That is, the bones are modeled but are not transformed for deformation under force. A different method, namely the direct least squares method, can ensure that the bones maintain their shape and proportions. Encoding relative positions and/or encoding a change in position of a bone, involves a global transformation, where each volume point in the presumed rigid structure of the bone is subjected to the same transformation (unlike host mesh fitting where each volume point in a deformable structure may be subjected to a different extent of transformation).

To perform the transformations on bones that are inferred from exterior views, data points are generated on the surface of the skin mesh in the initial and final positional configurations, at points selected to correspond with the location of the bone of interest, such as the end of a bone engaging another bone at a joint. The transformation between the changed positions of a limited number of spaced points on a rigid structure can be extended to determine the corresponding changed positions of all other points on the rigid structure.

One advantage of a host mesh fitting technique is that only a small number of points (for example a few hundred) may be required to deform the model allowing repositioning effects to be computed quickly while maintaining accuracy through the process of re-fitting. Where required, the positions of other points can be inferred, e.g., by interpolation.

Host mesh fitting is advantageous as practical technique for this purpose. It is also possible to develop seated-type model data directly from MRI scans or ultrasounds performed in a pseudo-seated position, to determine the relative positions of anatomical features versus those of the chair or other product. However, vertical MRI machines and machines that might reasonably accommodate both the subject and the product are likely to be expensive or impractical. Therefore, a subject is more aptly modeled using MRI scans or other measurements from more conventional medical imaging techniques to define the structure of the subject, followed by transformations to determine the relative locations of anatomical structures when the subject is seated (or otherwise positioned) with the limbs arranged differently. In one technique, MRI scans are used to encode that anatomical structures of a model to be examined in a seated attitude, by scanning the subject when lying on his or her back with the legs supported and bent at the knee, e.g., at 90 degrees. The models are then developed from these images.

To demonstrate the interaction between the customized model and an external device, the example of the office chair is discussed. However the same considerations may be applied to customizing any product that is to contact the subject or to be manipulated by or relative to the subject. To exploit the detailed anatomical models that are made possible according to this technique, it is appropriate to apply realistic boundary conditions that capture soft tissue interaction with the seat, i.e., contact between two at least partly resilient masses. It is also appropriate to assess the coupling of forces to the supporting structures, i.e., bones and muscles. In one example, X3 XSENSOR Technologies pressure mats were used to record the pressure between the subject and chair structures at discrete points on the surface of a seat during sitting. A mat was used having 1,296 sensors at 1 cm intervals in a 36×36 array. Pressure was recorded as the subject settled down on the chair, until a steady pressure value was reached.

A grid containing these pressure values was overlaid on the skin mesh of the model, to enable calculation of average pressure experienced at each point corresponding to or adjacent to encoded skin mesh elements. Stress and deformation in the skin and individual muscles are calculated by solving the non-linear equations via Newton's method. Pressure is applied to the legs and buttocks in the model and a suitable constitutive model (e.g. Mooney-Rivlin or Pole-Zero) is adopted to define the material properties of the muscle and skin.

To improve the analysis using the model, contact mechanics is used to examine interactions between different muscles, between muscles and skin, and between skin and external material. Contact mechanics analysis allows sliding and friction to be considered and increases the accuracy of the model.

The model as described is useful to assess different chair designs before manufacture, to compare different manufacturers' chairs versus the characteristics of subjects and to assess the fit and comfort of chairs for a range of subjects whose statistical distribution of model features are known from the database. Another use of the model is to customize a generalized chair design to fit a given subject configuration. Virtual testing is made possible to determine where the highest stresses occur and can be used to modify a virtual chair design to reduce stress and/or to distribute stress differently, e.g., more evenly or widely, before the chair is ever manufactured.

In further refinements, it is possible to analyze how long a subject is able to sit still in one position on the chair before needing to move to relieve stress. The analysis can be conducted together with other activity assumptions, such as viewing a computer display, typing or manipulating a mouse. The model can be applied in detail to analyze stress on individual muscles or muscle groups, based on human anatomy, the general ability of humans to maintain balance using muscle control, and also on the variance of a given subject from nominally assumed sizes and configurations of limbs and muscles. These techniques can produce better results than attempting to treat the muscles as simply a compressible soft tissue mass. Modeling with individual muscles is more accurate than grouping muscles together as a group for solving for forces applied during sitting. For further accuracy, the muscles can be modeled for their width, anatomical connections and interaction with adjacent muscles and other structures, rather than representing muscles as resilient line models with contraction characteristics alone.

A customized model of the subject and the chair can help to optimally adjust a chair that has adjustable features such as relatively movable and tiltable seat and back adjustments, a lumbar pad support, movable armrests, etc. Basic measurement details for a subject, taken from the anatomical model, provide inputs from which a computer program can readily calculate a nominal chair set-up for the subject. This technique can determine how adjustments to various aspects of the chair (such as seat height, seat depth, arm rest position, and lumbar support) can fit the subject's body shape.

Subjects also have preferences. By collecting data describing the range of sizes of the human subjects and the adjustments that are actually made by a target population of users, such preferences can also be taken into account as another attribute that defines the human subject. If it is determined thereafter that there is a cross correlation between attributes (e.g., perhaps persons who prefer springy chairs also prefer soft mattresses), this datum can be used to assist in the design and customization of products (chairs and mattresses) to fit the general population, or perhaps to point to the need for a range of products to accommodate different attributes among persons in the population, including both preferences and anatomical configuration details.

Further refinements of the product configuration application of the invention are possible, particularly if the modeling supports additional levels of detail. For example, by further modeling the circulation of blood flow through muscles, the correlation of blood flow and stress or comfort can be assessed with respect to how the chair affects blood flow (e.g., impeding blood flow at pressure points leading to discomfort or numbness) when the subject sits for a time on a particular configuration of chair.

The modeling of anatomical structures to design complementary structures is very apt with respect to prosthetic devices. An example is the precise configuration of hip replacement implants. Hip implant operations are relatively common. The typical process is for the surgeon and the patient to choose a hip implant from a limited selection, the choice being based on the gross anatomy of the patient and often the preference of the surgeon. The choice of the implant can influence the long term outcome of the hip operation. By using a subject-specific model of the patient, techniques can be used to select or design an optimal implant for the patient. The selection or design would aim to optimize the comfort of the patient, to minimize the surgical intervention, and improve the long-term outcome of the operation. The subject invention applies multiscale and multiphysics modeling and subject-specific models to optimize hip implant operations.

A subject-specific model database and a database of implant device models are preliminarily established. The subject-specific model comprises variables defining the musculo-skeletal system of the subject's body, and can be based on variance from a nominal or ideal model as described above. A subject-specific model of only the hip region can be used for a simplified simulation. A whole body model can be used for dynamic loading simulations involving other limbs and joints and their motions.

The models of the subject's body parts (bones, muscles, connective tissue, blood vessels, etc) and the implant devices preferably are represented using high order elements, such as cubic-Hermite elements. The implant device model is loaded from a database and automatically positioned in place using a fitting algorithm that optimize the distance between important surfaces of the bone and implant surfaces, respectively. For example, the ball of the implant device is fitted in place of the ball of the femoral head and the shank of the hip implant is aligned with the inside surface of the shaft of the femur.

An alternative to selecting among alternative existing implant models is to design a custom implant to the fit the subject. The custom design can be based on a generic standardized hip implant to which variances are applied to modify the implant configuration to fit precisely the anatomy of the patient's hip and femoral head. The fit is optimized according to criteria including, for example, to minimize the error between important surfaces of the implant and bones, to minimize the extent of surgical intervention, to optimize the strain distribution, to optimize the long term outcome by facilitating bone remodeling, or a combination of these.

The entire selection and implant configuration process can be automated, such that a subject-specific model is submitted and all implant models in the database and the custom design are tested against the subject-specific model. Then the surgeon can make a decision based on a quality-of-fit criterion as to which implant to use. The custom implant may offer a slight improvement over off-the-shelf models, but the surgeon may decide to go for the off-the-shelf option.

Information associated with the implant device model includes information regarding the necessary surfaces at the bone/implant interface. Therefore, application of the model can include a series of surgical steps for trimming or reaming bone from the hip and femur in order to fit the implant to the subject's bones. The models of the bones (hip and femur) are re-meshed when cut. The cutting surfaces can also define reference surfaces or boundaries between the bones and implant, useful for kinetic simulation. Kinetic simulations include the calculation of stress and strain using finite elasticity. The stress and strain can be calculated under different static loading conditions, for example, when the patient is standing or sitting, and under dynamic loading conditions, for example, walking or cycling.

Dynamic loading is simulated using kinematic models. The movement of the subject's model is simulated according to available data, for example including gait tracks. Through the movement, finite deformation models are solved to obtain the stress and strain. Contact mechanics models are solved to ensure muscles and bones do not inter-penetrate.

Bone remodeling is a cellular process where osteoclast and osteoblast cells remove old bone and add new bone, respectively. The amount of bone removed or added depends on a number of factors, including strain and the chemical composition. The simulation of bone remodeling is important for predicting the immediate and long term outcome of surgery. Models governing bone remodeling due to strain are coupled to the finite elasticity and contact mechanics models to simulate the changes in the bone structure over time. Although the bone remodeling models available today are simple and in their infancy, for instance, they are only dependent on strain, more advanced models, which depend on chemical composition, can be included in the inventive modeling techniques. Additionally, the chemical composition of the environment will depend on interstitial fluid within bone and blood delivery to the site, in which case, a subject-specific model of the bone structure, interstitial fluid flow, blood vessels and blood flow are required. This is an example of multiscale modeling (cells, bone structure, blood vessels, and bone geometry) and multiphysics modeling (bone remodeling, interstitial and blood flow, finite elasticity, and contact mechanics).

Bone remodeling can be simulated under daily stress conditions. Based on the results from the model, consideration can be given to achieving the best immediate and long term outcome, and not only with regard to structuring the implant but potentially also with regard to lifestyle choices. The model may simulate bone remodeling in the situation where the subject is walking, running or climbing stairs. The outcome of these simulations may suggest that the subject avoid stairs, in which case the subject may move to a single level house. The model may simulate the bone remodeling in the during the recovery stage due to exercise such as walking, swimming and cycling. Results from such simulations can lead to an improved healing process.

The foregoing applications of the inventive model contemplate a model database defining a person-specific model and a model database containing the person-specific models of other persons. Additional information including demographic data adds to the value of the model information in the database. With a large number of entries in the database, the ability to define sub-population groups opens the potential to treat subpopulations as distinct for various purposes, including inferring likely parameter values when measured values are not available. In a case where a given population has a correlation between variables, the additional information provides a higher level of validation or confidence in the accuracy of the derived model including any assumptions that might be made due to the distribution of values for one or more parameters among members of the population or subpopulation. Similarly, the manner of data collection may affect the confidence level of a measurement, for example such that dimensions based on two dimensional imaging such as X-Ray or ultrasound input might be given a lower validity score than, for example, three dimensional MRI image slice processing techniques.

When an object or application is to match the needs of a distinct population, the aspects of the population may be considered. For example, a bicycle saddle for women's bicycles might be designed with respect to the wider hips of women as compared to men. This and other features apt for women's bicycles can be taken into account according to the invention by limiting the population of model data input to females. Although in the example it is quite well known that women have wide hips, the same sort of benefits in data processing would accrue for cross correlations between other variables beside gender and hip size. Cross correlations can be determined from the data in the full database, and variable inferred with improved accuracy from a population specific subset as compared to the full database. Database entries not matching the specific subset population are discarded and the remainder represents the target population. This can be used by a manufacturer to define a range of product variants that will suit this specific population. The design of an object can also be optimized to best match a range of people within this specific population. It will also identify the number of people that a particular product will suit within the specific population. This information can be used as part of the design process targeting extending this range. It will also be valuable for marketing, forecasting demand and managing supply chains.

An alternative similar process can be applied where an existing product can be tested against a full database and the subset of the population that is most fitted or suited or likely to prefer the product can be analyzed for common factors. This information can assist in marketing by identifying marker characteristic that distinguish likely consumers of the product from others.

Apart from applications that classify the population of subjects into categories, or applications wherein products are configured or selected for all subjects of certain dimensions, for example, the “class” of subjects to be distinguished can be as fine as a single person. The stored subject specific models in the database can have anatomical and biophysical characteristics that are unique to a single individual, particularly when a number of separate distinguishing characteristics are required in combination to match an individual. This aspect allows the subject model database to be used as a security tool for determining the identity of a person by matching observed or measured attributes to stored data from at least a subset of potential subject models. New person-specific models can be based on the closest generic model. Simple person-specific data (e.g., any of gender, height, weight, ethnicity) is used to pre-select a close match from this subset of generic database models. This enables the detailed fitting processes (e.g. host mesh fitting) to proceed more rapidly. Accuracy can be enhanced where anatomical differences may exist between an individual and a sole generic model (e.g. number of tendons, presence of specific teeth).

Once a person is fully grown, certain precise personal measurements, such as the length of particular bones, are permanently fixed. In combination, these and other aspects are potentially powerful security and identity screening attributes. An example might be to improve border security screening in connection with immigration, visitor visas and the like. Upon a subject applying for a visa, the visa granting country performs a part or whole scan to derive measurements that are specific to the subject. The scanned body or body segment parameters are converted into a detailed model using the host mesh fitting techniques as detailed in the above description of custom fitting an office chair to the subject. However, the measurements are simply stored for future reference when the identity of the subject is to be matched against the subject applying for the visa.

One practical example is a hand scan, including but not limited to, a surface scan (camera or laser), X-Ray two dimensional or MRI three dimensional slice scan. From the scanned data, the generic model information for the specific subject is composed, using the described host mesh fitting techniques, to fit the scanned data. The result is a detailed three dimensional surface and subsurface hand model based on the results of the scan.

It is possible that numerous persons might have one or a few measurements in common with those of a random subject. However when one compares a large enough number of parameters, it is unlikely that two subjects have equal values for all of the parameters. Details may include the geometry of bones, dimensions at certain points, relative sizes, the interrelation of the bones with each other, irregularities due to healed bone breaks, scars and other factors. This hand model data can be added to the passport information and photo identification available in a networked database for reference when attempting to determine or verify a subject's identity.

At border crossings, passengers have their hands scanned, and a new model is created. Due to the ability of the model to be manipulated, e.g., examined and articulated at joints, variations resulting from different hand orientations and postures can be processed away. The newly scanned hand model and the data based model are compared to determine or verify identity. If the differences in variables that are substantially unalterable is above a threshold, such as the lengths of individual bones in an adult, a warning is signaled challenging the subject's identification.

A hand scan is just one example of a security verification technique wherein a collection of specific measurements of a subject can be encoded and recorded in sufficient number and accuracy, to enable the subject's identity to be determined or confirmed by later re-encoding and comparison against the previously encoded measurements. The same techniques and principles could be used, but not limited to, models of a whole body, or selected portions of a body having substantial degree of complexity and uniqueness (e.g., a hand, a foot, the skull, etc.). Without limitation, model parameter values that when combined with one another and/or with the values of other are substantially unique to an individual can include gait, namely the mathematically-defined specifics of a persons natural walking motion, facial specifics, which include at least the relative position and character of features and may also include a modal analysis of facial expressions, and other characteristics that are peculiar to individual persons. These variables can be used in lieu of or in addition to other physical attributes to distinguish a person from others.

The scan information that assists in defining characteristic aspects that in combination may be unique to an individual can be acquired from X-ray imaging modalities for mainly skeletal imaging, MRI or some other modality of scan for soft tissue, muscle and even blood vessels information, visible imaging by camera or raster laser scanning for surface geometry, etc.

It will be apparent from the forgoing discussion that the invention relates to methods and systems for storing, retrieving, generating, analyzing and using biophysical information for defined applications. Biophysical information as discussed herein relates to the human body, but the invention also is applicable to other living entities, and in different embodiments includes anatomical data (e.g. physical dimensions, musculo-skeletal data), functional traits and associated data (e.g. gait, electrical activation, physiological processes) and also situational non-measured data (e.g. demographics, family history, ethnicity, medical records).

In one form, the invention is a method for processing biophysical information involving the steps of providing data storage with at least one data processor in data communication with the data storage. The data processor is programmed for maintaining a database of biophysical information on at least one but preferably a number of human subjects. Storage of biophysical information and model data may occur in a remote database which could be centralized or distributed; or data may be stored on a local portable device such as personal music player or mobile phone. Similarly, data processing can occur at a local processor or a remote processor, or the processing load can be distributed and shared. An influencing factor is the amount of processing required. For more intensive processing, additional computing resources could be recruited through making use of one or more powerful computers. Communication can occur over any of the following; electrical buses within a device, over a wireless network for mobile applications, and over telephone or network communication systems such as LANs and WANs.

Appropriate security protocols preferably are implemented to handle privacy issues such as authorization requirements, log-on processes, password access, data encryption and the like. Such steps protect sensitive personal information and medical information identifiable with a particular person relevant to a specific application. Alternatively, such steps can be used in connection with providing data processing access for which services are billed.

The method include establishing and configuring the database to manage, for human subjects, measurements of biophysical parameter values and associated information relating to at least one physical subsystem of the human subjects. The database has identifiable fields for storing measurements of specific parameter values and information, thus characterizing individual subjects according to a physical metric. A biophysical subsystem or physical subsystem in this context can be construed, for example, as a group of organs, or parts of the body, that cooperate. A biological parameter is a characteristic that is measurable, such as length, width, weight, etc. A biological parameter value is the measurement itself (a number and the units of measure). And a biophysical metric can be regarded as a group of biophysical parameter values that are pertinent in some way to one another or pertinent to something outside the group, so that it is meaningful to group them together. Variations in the parameter values imply a change in the metric, but the change may be due to two or more parameters that might add or offset each other.

Associated information is data which is related to an individual and the individual's characteristic, but is not information that might be regarded as direct measurements. An example might be the number of finite elements required to represent the surface geometry shape of the femur to within a root mean square accuracy of 0.5 mm.

The database can be used to store a wide range of biophysical information virtually characterizing the subjects as to a broad range of attributes. However, for many uses, concentration is needed on selected physical subsystems that are associated with a relevant function. For example, use of the database with respect to a selected physical subsystem can involve measurements and information as to connected bone, muscle and connective tissue associated with ambulation, possibly also including cooperating physical subsystems, such as respiration, nutrition, circulation and neurology in the example of ambulation. In this context a physical subsystem is a subset of the part of the body and systems within the body which are relevant for a specific application. When considering fit of a prosthetic device to replace a femur head, the weight and position of the torso is relevant to the modeling of forces transferred to the femur head, but a detailed representation of internal torso organ systems is not required. In that example, the leg and upper body structures are a relevant physical subsystem.

The database fields are loaded from different data sources. Examples of data sources include: direct measurement of physical parameters and keystroke or automated data entry, e.g. height and weight; derivations obtained from direct measurements, e.g. anatomical data derived from an MRI image; derivations of a biophysical parameter obtained using a computational model, e.g. stride length, tidal lung volume; results from testing e.g. hormone levels, blood type, etc.

Data fields preferably are tagged with information about the source and level of accuracy. A field so tagged may be updated when more accurate, more reliable or newer data is available. This can happen in response to new measurements or new derived data, for example when inferring probable changes in physical appearance due to aging. A database may contain information on one person but advantageously contains information on multiple persons, and preferably documents a large population.

The database is useful for many purposes, not limited to medical and therapeutic applications. Employers or industry groups can establish databases for their workforces. An employer can require new employees to supply data populating the database fields to enable workplaces and equipment to be set up to adhere to ergonomic best practice, to reduce the incidence of workplace injuries, to manage systems for providing staff uniforms and equipment.

When a plurality of human subjects are included in the database, sub-populations can be defined based on the physical metric. An individual can belong to a sub-population if they have a characteristic that distinguishes that sub-population, alone or in combination with other characteristics. A sub-population is based on any identifiable anatomical, functional or non-measured characteristic or combination thereof, for example sex, age, nearsightedness, left-handedness, blood type, etc.

According to certain advantageous embodiments, data is applied and/or viewed using at least one model relating to at least a category of the subjects. The model comprises a process for manipulating the biophysical parameter values and associated information to deduce how the biophysical parameters affect the structure and functioning of the physical subsystem. Various models can be defined or hypothesized, which models reflect how the data values that concern one or more physical subsystems affect how the physical subsystems work. Models can be based on a deep analysis of applicable biology including the interaction of cells and blood circulation or neural function down to a microscopic scale. Or the models can be gross mechanical models of members, forces and linkages when the pertinent issues concern an analysis of the range of motion of bones and joints. These are non-limiting examples of a wide range of models whereby data values are subjected to useful manipulation. The software used to access the database of stored information can implement a multitude of models that represent different sub-systems and functional computations, individually or in demonstrating interactions. In this invention, a model is chosen to enable desired biophysical parameters to be computed. The choice is made based on the desired output, level of accuracy and matching of computational effort to computational power availability to the data processor.

The invention can be directed to the structures of a physical subsystem or its functions, or both. In this context, the “function” of a physical subsystem is how the subject uses and benefits from the elements of the subsystem. A physical subsystem can have multiple functions. The functions of a hand include grasping, pointing, punching, playing a musical instrument, etc. The function of a back is supporting oneself, e.g., when bending, when upright, etc. On a different scale, the primary function of a muscle is controllability to retract. There are other functions including emitting heat, assisting venous circulation (for some muscles). The function of a gland is to secrete a given chemical/biological composition at a given rate, responsive to a given impetus

The various fields of the database store values of the biophysical parameters and information defining the physical metric of one or more particular subjects. In the case of a database documenting a large population, the information might encompass a range of values of the physical metric. This enables information about the population to be inferred by using models, in a way similar to the way in which the models can be used to view the physical subsystems of an individual.

Preferably the database for one subject or for many subjects conforms to a generic model that includes many parameters. It is possible that information for a field is not known for a particular subject (although the average value for similarly situated subjects might be computed), or perhaps the accuracy of certain values for representing the specific subject has not been validated. As more and more real data becomes available about an individual, the parameter values and the associated confidence in the accuracy of the database parameters representing that individual increase. Thus, one can establish a database entry for a fully specified virtual subject—but the values represent a mean or average (“JoeAverage”). The full set of parameter values are a virtual model of a nominal individual. By adding or revising a value to apply to a person-specific parameter value, the database record begins to become customized to that individual. But at all times, the database record contains a complete virtual model that to some extent approximates the specific subject. If one adds a parcel of actual data (for example various measurements taken from a photo), the customization gets better. If one adds internal organ specifics, e.g., from MRI data, one can be rather confident that the morphing of the original JoeAverage record to the person-specific version now has customized the model to accurately represent the individual.

More useful data can be incorporated in the database record. One category is performance data—how high can this person jump? It is possible that medical and laboratory test results may be available for the person and become useful as data field values that may help to reflect the nature and function of physical subsystems. Processing steps associated with modeling data in the database fields representing a physical subsystem preferably can distinguish inferred average values from real values and preferably also can refine or adjust original average values for a subject after certain real measurements are known.

For database fields which are unknown, a model can be provided to assist in estimating unknown biophysical values from known values. Such a model may be very simple. For example, measurements of a series of linear elements, (e.g. legs, torso, head) can in combination estimate total height. This model would also be sufficient to estimate the leg orientation for a specified seat height. More advanced models could incorporate any of the following; accurate anthropomorphic measurements, full surface geometry such as available from a body surface laser scanner system, internal anatomical data from 3D scanners such as MRI, functional data such as metabolic rates. As more accurate and comprehensive data is incorporated into more advanced models, additional biological parameters can be derived, e.g. derivation of growth profiles, remodeling of tissue after injuries or progression of bone remodeling following the implantation of prosthesis.

The database can be mined for statistical information when a sufficient population of subjects is encoded to be statistically significant. In that case, a range of values for one or more biophysical parameters can be inferred for a subject that is found to be included in a distinct sub-population, having one or more traits in common with the subject. For example, when determining the girth of a 22 year old female subject whose height is known, the operator or an automated process may query the database for information on mean fat layer thickness for females aged 20-25 in the same height range, and thereby develop a useful average value measurement and a standard deviation that shows the level of confidence of that value.

To make use of the invention, access to the database is provided for selecting a subset of the subjects, applying the model to the biophysical parameter values and information found in the database for the subset of subjects, and computing from application of the model an output. The output may concern structure or function, i.e., at least one of an aspect of a structural characteristic of the physical subsystem and a function of the subject affected by said physical subsystem.

Individuals may have themselves measured in a similar manner to generate data for a personal dataset that enables the individual to obtain products or services of personal interest, e.g., those products that precisely fit the individual. Companies that endeavor to serve a large population of customers may wish to establish a database to better serve their customers. Employers may require employees to supply data to enable workplaces and equipment to be setup appropriately. Immigration services may require data for the purpose of identification.

For such purposes, a manufacturer may want to access the database to select a subset of the subjects to derive biophysical values from a sub-population (e.g. those within a specified age range). This will enable them to determine a range of products that satisfy the requirements of the sub-population. The database can also provide guidance on the variability within a population to assist with the refinement of a minimal set of sub-populations that adequately represent a viable commercial opportunity.

A manufacturer could test the functionality of a specific device to determine the sub-population that is suited to the product. The output may also suggest modification that will expand the size of the sub-population that matches.

The invention finds further utility when the associated information is represented at least partly by values stored in corresponding information fields of the database, and further comprising defining categories of the subjects based on such information fields maintained and stored in the database and operating the model on categories of subjects. With additional information fields are included at least one of an identification of individual subjects, demographic information respecting the subjects, and subject history information.

This information can be made available by the subject individual, by an organization of which the subject is a member, or by from service providers such as healthcare providers. Family history data can be obtained from surveys, questionnaires and research into historical records.

The similarities and differences between one individual and another or between one subset of the population and another, not only can be compared and correlated but also can be quantified and tracked over time. This is enabled by comparing at least one of the measurements of the biophysical parameters stored in the database and an output of the model developed from the measurements of the biophysical parameters, versus a later set of measurements of the biophysical parameters and a new output of the model developed from the later set of measurements. This process enables the assessment of changes in one of a subject and a subset of the subjects over time with respect to changing values of the biophysical parameters. Changes in subjects can be projected and estimated, such as male pattern baldness or decreased range of motion with age. One can also expect that some traits do not change over time. The process is therefore able to confirm a lack of changes between two sets of measurements with respect to similarities between the two sets of measurements. This may be used to test an individual for proximity to membership of a subset population, e.g. diabetics or cardiac heart failure. It has application for assessing risk profiles and insurance coverage.

Comparison of biophysical parameters obtained at different times is able to provide identification verification. Identity may be verified by comparing measurements with respect to individual subjects, wherein assessing of changes and confirming the lack of changes between the two sets of measurements comprises determining an extent of the changes and concluding whether the two sets of measurements were obtained from a same individual subject for one of determining an identity of the subject from the database and confirming a claimed identity for a subject. The use of a model using data obtained on day one to generate possible finger positions and then using data obtained at a later time to validate a match with a new set of finger positions provides validation more powerful than static tests like fingerprinting. A subject's identity may be confirmed by comparing the similarity of certain stable traits in two measurements, such as the distance between ocular orbits, while discounting other traits such as hair color or facial wrinkles that change over time or can be altered cosmetically or as a function of weight gain or loss.

In a further embodiment of the invention, a model of an external product is included in the computation processes, for example to configure or select or test the aptness of a product for a subject. The method comprises defining at least one external model relating to one of a product for use by at least a category of the subjects and a function associated with an activity of a category of the subjects. The product and the activity interact with structural characteristic embodied by the physical subsystem and function of the subject affected by the physical subsystem. By operating the model together with the external model it is possible to configure one of the product and the activity to complement an aspect common to members of the category of subjects; or to adjust one of the product and the activity to better complement members of the category of subjects; or to select among plural potential products and activities to suit members of the category of subjects.

The modeling and comparisons of results might be a simple process such as determining if a shoe will fit a foot. The modeling also can be more detailed, for example assessing the pressure distribution on the sole of a foot during a running gait. The latter requires an anatomical model with internal foot geometry but is wholly within the scope of the invention.

Fitting external objects that are compliant (many shoes or clothing), advantageously requires a model representation of these objects including material properties of the components. Such compliant objects may deform or may produce resilient pressure or may wear unevenly. Modeling provides information useful to select a product that fits, or for a manufacturer to configure the product for comfort and long useful life.

Modeling products advantageously takes into account the physical subsystems of the users, which are likewise the subject of modeling on their own account. Where the users are documented by the database and modeling systems of the invention, it is possible to configure apparatus as apt for a subject or for a subset or class of subjects. Conversely, given a product model (including a nominal model or an arbitrarily configured product model), one can select from among plural potential subjects represented in the database to find a subject or subset of subjects that have a predetermined relationship to the product model. One can likewise find a subject or subset wherein the defined product is apt for the subject(s) for accomplishing a defined activity. Additional possibilities include testing modeled use of the product by at least one selected subject, testing results of the modeled activity by at least one selected subject, and so forth.

An example of conforming subject and product models as well as uses is seen in the example of a cardiac pacemaker. Choosing the location of a pacemaker lead wire on a patient-specific basis is a potentially important detail in configuring a pacemaker installation. One object is to provide a normal excitation sequence for the heart of the patient. It is also advantageous to do so at the minimal necessary power delivery so as to extend battery life and lengthen the time until the patient must have the battery replenished. In this application a patient specific model includes cardiac anatomical, electrical and functional data. Laplace's equation is solved to determine how the electrical activation will propagate from the test location of the pacing lead wires. This process is time stepped and includes predicting the heart wall motion throughout the cardiac cycle. Models of cellular chemical processes are able to predict pacing current/voltage levels required to achieve depolarization.

On a more lowly level, models of user anatomical data and functional capability against models of gymnasium exercise equipment, such as force loading and movable part displacement details, enables a computation of optimal weight adjustments for a specific piece of gymnasium equipment on the one hand (the product model), and can be used to plan an exercise regime and even to project changes in muscle function over the exercise regime on the other hand (the biophysical system model).

Accessing the database to accomplish the foregoing can include access by an operator or access using an automated process. In the case of an operator or process, the entity accessing the system may be engaged in providing one of products and services to the subjects. In that case it is necessary only to process or to read out a sufficient part of the physical metric and an output of the model to derive an attribute of said one of products and services to complement the subset. Although the database can be a collection of widely varying variables and substantially unrelated biophysical subsystems, the accessing entity processes or reads out so much of the information as suits its needs. Similarly, a user who controls access to information concerning the user (as a subject representing in the database) may choose to release to a given entity only certain fields of information, or may choose to grant authorization the right to access only certain of the potentially available models and model processing subsystems.

A physical metric that might be processed may be that of an individual subject or may be that of a category of subjects selected by values for said database fields as entered by the operator. Selection by similarities and differences in physical metrics is one way to associate subjects into relevant subsets. Preferably various statistical data processing tools are made available for use by the operator or process that accesses the database. For example routines are aptly provided for generating and reporting to the operator a statistical range of physical dimensions, for cross correlating variables, for sorting lists on various variable values, for linking lists and generally for manipulating the database contents.

The physical metric being employed at any given time may represent an actual subject, a nominal subject, a subset selected for some criteria, a processed set of subject data, etc. As stated above, the metric may refer to a biophysical system or subsystem, such as body part to be tested for fit to one of a manufactured article or service, or may refer to the article or service. In this context, the fit between an article or service and a biophysical subsystem includes internal fit, e.g., as in the fit of surgically installed prostheses inside the body of a subject, as well as external fit.

In a preferred arrangement, at least part of the database information is provided using medical scanning and imagery to obtain internal views, dimensions and information. Thus the parameter values and information for the physical metric is derived at least partly from a scanning system chosen from the set consisting of three dimensional image scanners, MRI scanners, CT scanners, X-Rays, ultrasound NMR spectra, magnetic field and Terahertz electromagnetic imaging.

As stated above, some information about a subject can be tentative information, such as values that are applicable to a nominal subject. Some processed values are derived from values of a nominal subject but are varied, for example because a measured value for a given variable for the specific subject was different from the nominal value, and the measured and processed variables are known to be variables that are typically correlated. Stated another way, values in the database fields respecting the subjects, including said physical metric and at least one additional field, can be such that a value for at least one of said database fields representing the physical metric for a subject is unknown. However, a probable value to be tentatively applied to that database field is derived from a distribution of relationships between values for at least two said database fields.

Where the biophysical information in the database represents a virtual model of a human with anatomical components, and is derived from image analysis steps applied to at least one image collected representing at least part of the subject, the image can comprise a succession of two dimensional image slices and the physical metric is derived from the slices and a predetermined spacing of the slices in a direction normal to their planes.

It should be noted at this point that although the database variables that make up the physical metric have been discussed to a large extent as dimensions, it is also possible to express the physical metric using a number of variables that are more functional. Examples include tension forces exerted by muscles, flow rates and volumes for respiration or blood flow, accumulated force and displacement (work) and work versus time (energy) variables can be defined and associated with exercise and so forth. As to parameter values that comprise anatomical measurements, typical dimensional data and other data include one or more of length, width, mass, volume, etc. Bone and joint configurations can be encoded, not limited to type (e.g., hinging or ball/socket) but also perhaps including range of motion, status of connective tissue, arthritic lining states, etc. Aspects of texture, tone, coloring and contour complexity can be included for at least one body part of the subject, especially when processing for aspects of appearance (e.g., facial features).

For epidemiological use, assessment of disease conditions in subsets related genetically and for determining various other relationships, the associated information stored in the database for a subject advantageously includes demographic information and may include medical history information. Included measurements of function can comprise one or more of blood pressure, pulse rate, electrocardiographic data, lung capacity, air flow rates, lung efficiency, body fluid diagnostic results, sensory data or physical performance data.

An advantageous embodiment of the invention thus comprises, in addition to the database and biophysical modeling aspects, a system for creating a user-specific article of manufacture. The system includes a model of the body, a model of the article and data for manufacturing the article.

The model of the body is a biophysical virtual model of the user's body based on functional and physical body data, wherein at least one of an anatomical and a functional component of virtual model are integrated, and further wherein at least one of said anatomical and functional component of the model are constrained by conservation laws, i.e., by certain laws that define whether elements can or cannot intersect, whether elements are coupled or uncoupled or perhaps coupled by one mechanism versus another, etc.

The virtual and generalized model of an article of manufacture is able to represent the article in the situation when the article correctly fits the user's body. An output is a manufacturing data set representative of the user-specific virtual model of the article of manufacture, for use in creation of the article of manufacture customized for the user, or perhaps the selection of the most appropriate size or type for a customer, from a range of sizes and types in inventory. The adjustments of the model of an article model are directed to improving function of the manufactured article when used by the user.

The design of a pogo stick is described to illustrate the process. The model for the pogo stick includes the stick, handle, spring, and foot rests. The biophysical parameters for the user include initially whatever data is available on total body weight, leg dimensions, arm dimensions and the musculoskeletal system and functional muscle strength. The amount of data available will vary from subject to subject. Missing biophysical parameters are supplied from a generic or nominal subject that is modified and constrained by the available data for that subject, and possibly refined by data available for a group of subjects of which the specific subject is a member.

The ultimate suitability of the design of the pogo stick is a function of the accuracy of the data available for the subject. More data will provide a better design and less data will introduce uncertainty because the physical parameter values that specify the subject may vary from the specifications of the nominal generic subject.

Modeling operation of the pogo stick and biophysical operations of the subject, particularly in combination with one another (e.g., the subject's feet on the pogo stick foot rests; the subject's leg muscles contracting rhythmically in opposition to the springs, etc.) generates a series of postures and positions as the user bounces on the pogo stick for a given set of pogo stick design parameters. Design parameters in this example could include handle height, spring constant and spring length. An optimization routine perturbs the design parameters, and an objective function is calculated for each perturbation, thereby identifying the ranges of parameters that maximize (or minimize) objective functions that are desired (or undesired). The objective function is a function of bounce height, forces acting through the feet, stress and strain produced in each joint. The maximum value of one or some collection of positive objective functions determines the best design parameters for a pogo stick for this user.

While the present invention has been illustrated by the description of the embodiments thereof, and while the embodiments have been described in detail, it is not the owner's intention to limit the scope of the appended claims to such detail. Additional advantages and variations within the scope of the invention will now be apparent to those skilled in the art. Reference should be made to the appended claims as opposed to the foregoing disclosure of examples, to determine the scope of the invention in which exclusive rights are claimed.

What is claimed is:

1. A method for processing biophysical information, comprising;
providing data storage and at least one data processor in data communication with the data storage, wherein the data processor is programmed for maintaining a database representing biophysical information on a number of human subjects;
establishing and configuring the database to manage, for a plurality of said human subjects, measurements of biophysical parameter values and associated information relating to at least one physical subsystem of said human subjects, wherein the database has identifiable fields for storing measurements of specific parameter values and information, thus characterizing individual said subjects according to a physical metric;
defining at least one model relating to at least a category of the subjects, wherein the model comprises a process for manipulating the biophysical parameter values and associated information to deduce how the biophysical parameters affect the structure and functioning of said physical subsystem;
providing for corresponding fields of the database, values of the biophysical parameters and information defining the physical metric of at least one particular said subject, thereby obtaining information encompassing a range of values of the physical metric;
accessing the database for selecting a subset of the subjects, applying the model to the biophysical parameter values and information found in the database for at least a subset of subjects, and computing from application of the model an output concerning at least one of an aspect of a structural characteristic of the physical subsystem and a function of the subject affected by said physical subsystem.

2. The method of claim 1, wherein the associated information is represented at least partly by values stored in corresponding information fields of the database, and further comprising defining categories of the subjects based on such information fields maintained and stored in the database and operating the model on said categories of subjects, wherein the information fields include at least one of an identification of individual subjects, demographic information respecting the subjects, and subject history information.

3. The method of claim 1, further comprising from time to time comparing at least one set of the measurements of the biophysical parameters stored in the database, the physical metric, and an output of said model developed therefrom, versus a later set comprising at least one of the biophysical parameters, the same or another said physical metric and a new output of the same or another said model, for assessing one of a subject and a subset of the subjects over time, wherein said assessing comprises comparing and distinguishing values for one of determining that particular aspects of the parameters, the physical metric and the output have changed, confirming that said particular aspects have not substantially changed, and determining an extent of change in said aspects.

4. The method of claim 3, comprising comparing said measurements with respect to individual subjects, wherein said assessing of changes and confirming the lack of changes between the two sets of measurements comprises determining an extent of the changes and concluding whether the two sets of measurements were obtained from a same individual subject for one of determining an identity of the subject from the database and confirming a claimed identity for a subject.

5. The method of claim 1, further comprising defining at least one external model relating to one of a product for use by at least a category of the subjects and a function associated with an activity of a category of the subjects, wherein the product and the activity interact with said structural characteristic embodied by the physical subsystem and said function of the subject affected by said physical subsystem, and further comprising operating the model together with the external model for at least one of:
configuring one of the product and the activity to complement an aspect common to members of the category of subjects;
adjusting one of the product and the activity to better complement members of the category of subjects;
selecting among plural potential products and activities to suit members of the category of subjects;
selecting from among plural potential subjects represented in the database a subject having a predetermined relationship to one of a defined product and a defined activity;
testing modeled use of the product by at least one selected subject; and,
testing results of the modeled activity by at least one selected subject.

6. The method of claim 1, wherein said accessing includes access by an operator engaged in providing one of products and services to the subjects, and further comprising reading out at least a sufficient part of the physical metric and an output of the model to derive an attribute of said one of products and services to complement said subset.

7. The method of claim 6, wherein the physical metric is that of an individual subject.

8. The method of claim 6, wherein the physical metric is that of a category of subjects selected by values for said database fields as entered by the operator.

9. The method of claim 6, further comprising generating and reporting to the operator a statistical range of physical dimensions.

10. The method of claim 7, wherein at least one said physical metric represents a body part to be tested for fit to one of a manufactured article.

11. The method of claim 7, wherein at least one said physical metric represents a body part to be referenced to design an article of manufacture.

12. The method of claim 7, wherein at least one said physical metric represents a body part to be tested for fit to a manufactured article for use inside a body of the individual subject.

13. The method of claim 7, wherein at least one said physical metric represents a body part to be tested for fit to a manufactured article for use outside a body of the individual subject.

14. The method of claim 1, wherein the physical metric is derived at least partly from a scanning system chosen from the set consisting of three dimensional image scanners, MRI scanners, CT scanners, X-Rays, ultrasound NMR spectra, magnetic field and Terahertz electromagnetic imaging.

15. The method of claim 1, wherein the memory is configured to manage a plurality of database fields respecting the subjects, including said physical metric and at least one additional field, wherein a value for at least one of said database fields representing the physical metric for a subject is unknown, and further comprising deriving from a distribution of relationships between values for at least two said database fields a probable value for the physical metric that is unknown.

16. The method of claim 1, wherein the stored biophysical information represents a virtual model of a human with anatomical components, wherein the biophysical information stored in the database is at least partly derived from image analysis steps applied to at least one image collected representing at least part of the subject.

17. The method of claim 16, wherein the image comprises a succession of image slices and the physical metric is derived from the slices.

18. The method of claim 1, wherein the model comprises a biophysical virtual model customized by at least one of the biophysical parameter values and the associated information include anatomical measurements and measurements of function.

19. The method of claim 1, wherein the measurements components comprise at least one aspect that is constrained by universal conservation laws.

20. The method of claim 18, wherein the biophysical parameter values comprise anatomical measurements including dimensional data for at least one of:
mass, volume and bone and joint configuration, and morphology including at least one of texture, tone, coloring and contour complexity of at least one body part of the subject.

21. The method of claim 20, wherein the associated information further comprises at least one of demographic information and medical history information.

22. The method of claim 18, wherein the measurements of function comprise at least one of blood pressure, pulse rate, electrocardiographic data, lung capacity, air flow rates, lung efficiency, body fluid diagnostic results, sensory data or physical performance data.

23. A method for establishing a database containing biophysical information that is at least partly unique to a human subject, comprising;
providing at least one nominal human subject definition wherein a nominal subject is defined to have a plurality of nominal anatomical parts that are cooperatively related to service biophysical functions, wherein relationships of the parts are constrained according to conservation laws that are applicable universally to a population of subjects, and wherein the nominal subject definition comprises parametric measurements related to at least one of structure and function, expressed in numeric values;
providing at least one nominal product configuration, wherein at least one aspect of the nominal product configuration corresponds to the nominal subject definition, said aspect expressed in numeric values;
establishing and loading a database having database fields organized for anatomical measurements and functional measurements defining a biophysical metric for the human subject, wherein the database also is loaded with a respective said biophysical metric for each of a plurality of other subjects of the population, including numeric values for fields corresponding to the parametric measurements for the nominal human subject;
processing values in the database fields relating the nominal human subject definition and the nominal product configuration according to a model accounting for operative and dimensionally complementary relations between a human and a product using the product;
selectively choosing, comparing, varying and processing values from at least one of the nominal human subject definition and the nominal product configuration, for at least one of:
configuring a product to vary from the nominal product configuration so as to complement a selected subset of subjects in the population;
adjusting a product from one a nominal configuration and a previous configuration, to complement a selected subset of the subjects;
selecting among plural potential products to suit members of a selected subset of the subjects;
selecting from among plural potential subjects represented in the database a subset of subjects having predetermined attributes suited to a predetermined product configuration;
testing modeled use of the product by at least one selected subject; and,
testing results of the modeled activity by at least one selected subject.

24. The method of claim 23, wherein said choosing, comparing, varying and processing values comprises assessing a functional aspect of interaction between at least one subject and a product.

25. The method of claim 23, comprising configuring one of a movable apparatus to be operated by or on the subject, a supporting apparatus to engage a part of the subject and an article of apparel to fit at least the subset of subjects in the category.

26. The method of claim 25, wherein said configuring comprises adjusting an adjustable component of a product.

27. The method of claim 25, wherein said configuring comprises manufacturing a product component to one of a particular scale and shape.

28. The method of claim 25, wherein said configuring comprises one of manufacturing, adjusting and selecting the product for a particular range of mechanical function.

29. A system for creating a user-specific article of manufacture comprising:
a biophysical virtual model of said user's body based on functional and physical body data, wherein at least one of an anatomical and a functional component of said virtual model are integrated, and further wherein said at least one of said anatomical and said functional component of said virtual model are constrained by conservation laws;
a virtual and generalized model of an article of manufacture fitted to said virtual model of said user's body so as to yield a user-specific virtual model of said article of manufacture; and
a manufacturing data set representative of said user-specific virtual model of said article of manufacture for use in creation of said user-specific article of manufacture.

30. A method for processing biophysical information, comprising;
providing data storage and at least one data processor in data communication with the data storage, wherein the data processor is programmed for maintaining a database representing biophysical information on at least one human subject;
establishing and configuring the database to manage, for said at least one human subject, measurements of biophysical parameter values and associated information relating to at least one physical subsystem of said human subject, wherein the database has identifiable fields for storing measurements of specific parameter values and information, thus characterizing said subject according to a physical metric;
defining at least one model relating to the subject, wherein the model comprises a process for manipulating the biophysical parameter values and associated information to deduce how the biophysical parameters affect the structure and functioning of said physical subsystem;
accessing the database and applying the model to the biophysical parameter values and information found in the database for said subject, and computing from application of the model an output concerning at least one of an aspect of a structural characteristic of the physical subsystem and a function of the subject affected by said physical subsystem.

31. The method of claim 30, further comprising defining at least one external model relating to one of a product for use by the subject and a function associated with an activity of the subject, wherein the product and the activity interact with said structural characteristic embodied by the physical subsystem, and further comprising operating the model together with the external model for at least one of:
configuring one of the product and the activity to complement an aspect of the subject;
adjusting one of the product and the activity to better complement the subject;
selecting among plural potential products and activities to suit the subject;
testing modeled use of the product by the subject; and,
testing results of the modeled activity by the subject.

32. The method of claim 31, further comprising maintaining measurements in said database of biophysical parameter values and associated information relating to at least one physical subsystem of a plurality of human subjects and selecting a subset of the plurality of human subjects having an aspect in common and applying the model to said subset.
